(19) United States
(12) Patent Application Publication
(10) Pub. No.: US 2021/0179248 A1
(43) Pub. Date: Jun. 17, 2021

(54) PAYLOAD RELEASE SYSTEM FOR VERTICAL LAUNCH

(71) Applicant: LOON LLC, Mountain View, CA (US)

(72) Inventor: Vasil Tasovski, Newark, CA (US)

(73) Assignee: LOON LLC, Mountain View, CA (US)

(21) Appl. No.: 17/114,780

(22) Filed: Dec. 8, 2020

Related U.S. Application Data
(60) Provisional application No. 62/947,825, filed on Dec. 13, 2019.

(51) Int. Cl. B64B 1/00; B64F 3/00

(52) U.S. Cl. CPC B64B 1/005; B64F 3/00

(57) ABSTRACT

The technology provides a launch rig structure capable of filling a very large balloon envelope while the balloon is arranged vertically. The filled balloon is capable of staying aloft in the stratosphere with its payload for months or longer. The launch rig structure is configured to rotate up to 360° in response to current wind conditions. It includes an integrated lifting boom and gas handling system to fill the envelope. A payload release assembly is configured to couple with a rigid connection member of the balloon, enabling the envelope to be filled while in a vertical orientation. The payload release assembly is part of a launch cart that is positioned within the interior space of the launch rig. A gripper assembly engages with the rigid connection member. Once the envelope is filled, the gripper assembly disengages from the connection member so that the balloon floats away from the launch rig.

### CROSS-REFERENCE TO RELATED APPLICATIONS

This application claims the benefit of the filing date of U.S. Provisional Application No. 62/947,825, filed Dec. 13, 2019, the entire disclosure of which is incorporated by reference herein. This application is related to co-pending application Ser. No. 17/114,859, entitled Vertical Launch System, attorney docket No. LOON 3.0E-2240 [9105], and to co-pending application Ser. No. 17/114,714, entitled Vertical Fill Method, attorney docket No. LOON 3.0E-2230 [9072], filed concurrently herewith, the entire disclosures of which are incorporated by reference herein.

### BACKGROUND

Communications connectivity via the Internet, cellular data networks and other systems is available in many parts of the world. However, there are other locations where such connectivity is unavailable, unreliable or subject to outages from natural disasters and other problems. Some systems provide network access to remote locations or to locations with limited networking infrastructure via high altitude platforms operating in the stratosphere, for instance using lighter-than-air platforms such as balloons that take advantage of wind currents to stay aloft for weeks, months or longer.

Launch of balloon-type platforms involves inflating an envelope or other enclosure with lift gas. As the envelope is inflated, wind may cause the envelope to sway unpredictably. Thus, deploying balloons under less than ideal weather conditions can be very challenging. For example, launching such balloons in a windy environment can be potentially hazardous to bystanders, and in some cases, windy conditions can cause damage to the balloons or their payloads before they are fully inflated and deployed. Solutions such as using a wind shield to block wind from certain directions can become less useful when wind changes direction quickly, and the shield(s) may have to be constantly adjusted. Tower structures can be employed to protect balloons during inflation may work well until a balloon is actually launched and moves out of the exit at the top of the tower, or if the balloon envelope is very large, for instance having a length exceeding the height of the tower structure. A strong cross wind can cause the balloon to hit the tower, potentially damaging the balloon envelope or the balloon payload.

### BRIEF SUMMARY

Conventional balloon launches involve inflating a balloon envelope with lift gas, with part of the envelope restrained during fill. A launch platform with a restraining mechanism may be employed with a portable launch rig that may be adjusted depending on the wind conditions. However, as lighter-than-air high altitude platforms (HAPs) are made larger to enhance their operational capabilities and lifespans, the inflated envelopes may become significantly larger than a portable launch rig can enclose., which can be adversely affected by the wind before launch Also, restraining mechanisms that employ a releasable restraint for holding a portion of the balloon envelope during inflation and prior to launch may, in certain situations, place undue stress on the envelope, which can cause damage or otherwise shorten the operational life of the HAP.

Thus, in accordance with aspects of the technology larger and more permanent launch systems are employed to accommodate large HAPs. This includes a launch rig structure capable of filling the envelope while the balloon is arranged vertically. The launch rig structure is configured to rotate up to 360° in response to current wind conditions, and to protect against wind gusts exceeding, e.g., 20-35 mph. The launch system includes an integrated lifting boom and gas handling system to fill the envelope. A payload release assembly is configured to couple with a rigid connection mechanism of the HAP, rather than holding down a portion of the envelope during inflation. This enables the envelope to be filled while in a vertical orientation, which can further mitigate stress on the envelope.

According to one aspect of the technology, a payload release assembly is provided for securing a lighter-than-air platform during a launch operation. The lighter-than-air platform includes a balloon envelope and a payload coupled to the balloon envelope. The payload release assembly comprises a launch arm assembly and a gripper assembly. The launch arm assembly has a first end and a second end remote from the first end. The first end is engageable to a launch cart that is configured to store the balloon envelope. The launch arm assembly is configured to actuate between a pre-launch position and a launch position. The gripper assembly is operatively coupled to the second end of the launch arm. The gripper assembly is configured to secure a connection member of the lighter-than-air platform. The connection member has a shaft member and a crossbar. The gripper assembly has a first section configured to receive the shaft member and a second section configured to secure the crossbar prior to launching.

In one example, the first section of the gripper assembly includes a support block with a pair of fingers adapted to receive a portion of the shaft member. In this case, the first section of the gripper assembly may include a pair of guide rails, where the support block slideably engages the portion of the shaft member via movement along the pair of guide rails. The portion of the shaft member may be a first portion disposed along a first side of the crossbar. Here, the first section of the gripper assembly further includes a receptacle block adapted to receive a second portion of the shaft member. The second portion is disposed along a second side of the crossbar opposite the first side. Engagement of the first portion by the support block and engagement of the second portion by the receptable block prevent movement of the connection member along a longitudinal axis thereof.

In another example, the second section of the gripper assembly includes a pair of cradles configured to receive opposing ends of the crossbar. Here, each cradle may include one or more track rollers, and the cradles are rotatable to secure and release the crossbar during the launch operation. The gripper assembly may further include a pair of torsion springs, in which a first one of the torsion springs is axially mounted to a first one of the cradles, a second one of the torsion springs is axially mounted to a second one of the cradles, and wherein each of the torsion springs is configured to cause rotational preloading on the respective cradle in a closed orientation prior to launch. The gripper assembly may further include a pair of cradle latches, a first one of the cradle latches being operatively engaged with a first one of the cradles, a second one of the cradle latches being operatively engaged with a second one of the cradles, wherein each cradle latch is configured to prevent rotation of the respective cradle prior to launch. The payload release assembly may further comprise one or more cables configured to actuate the pair of cradles during the launch operation.

In a further example, the launch arm assembly includes an arm actuator configured to actuate the launch arm assembly between the pre-launch position and the launch position. In yet another example, the launch arm assembly further includes a gripper actuator configured to cause the gripper assembly to release the connection member of the lighter-than-air platform during the launch operation. According to an additional example, the launch arm assembly further includes a damper configured to decelerate the launch arm assembly upon release of the lighter-than-air platform during the launch operation. And in yet another example, the payload release assembly further comprises a control system configured to manage a sequence of actuations of the launch arm assembly and the gripper assembly according to a selected timing.

According to another aspect of the technology, a method of securing a lighter-than-air platform during a launch operation is provided. The method comprises setting a top support block of a gripper assembly in an open position; receiving a crossbar of a connection member of the lighter-than-air platform in a cavity of the gripper assembly; upon receiving the crossbar in the cavity, setting the top support block in a closed position for launch, the top support block constraining movement of the crossbar along a first axis and receiving a shaft portion of the connection member; and engaging a pair of cradles with the crossbar, the pair of cradles constraining movement of the crossbar along a second axis perpendicular to the first axis.

In one example, the shaft portion is a first shaft portion, and receiving the crossbar in the cavity further includes contacting a second shaft portion of the connection member against a receptacle block of the gripper assembly. In another example, setting the top support block in the open position includes retracting the top support block along a pair of guide rails. In a further example, engaging the pair of cradles with the crossbar includes rotating the pair of cradles from a first position to a second position so that one or more track rollers on each cradle secure a section of the crossbar.

According to a further aspect of the technology, a method of launching a lighter-than-air platform using a release assembly is provided. The method comprises retracting a cradle latch of a gripper assembly to enable free rotation of a pair of cradles engaged with a crossbar of a connection member of the lighter-than-air platform; retracting an arm latch of a launch arm assembly to enable unobstructed rotation of the launch arm assembly; and retracting a gripper actuator of the launch arm assembly to rotate the pair of cradles into a launch position, thereby enabling the lighter-than-air platform to disengage from the release assembly and float into the atmosphere.

In one example, timing of retracting the cradle latch, retracting the arm latch and retracting the gripper assembly is managed by a control system based on one or more of wind speed, mass of the lighter than air platform, or volume of gas within an envelope of the lighter-than-air platform. In another example, retracting the gripper actuator to rotate the pair of cradles into the launch position includes pulling one or more cables to cause one or more track rollers of each cradle to rotate into a release position.

### BRIEF DESCRIPTION OF THE DRAWINGS

FIG. 1 is a functional diagram of a balloon system in accordance with aspects of the disclosure.

FIGS. 2A-B are examples of balloons in accordance with aspects of the disclosure.

FIG. 2C is an example of a balloon payload in accordance with aspects of the disclosure.

FIGS. 3A-D illustrate views of a launch support system in accordance with aspects of the disclosure.

FIGS. 4A-J are example views of a launch rig and components thereof in accordance with aspects of the disclosure.

FIGS. 5A-L illustrate fabrication of parts of the launch rig in accordance with aspects of the disclosure.

FIGS. 6A-F illustrate an example of a lifting assembly in accordance with aspects of the disclosure.

FIGS. 7A-K illustrate aspects of a wind block assembly in accordance with the disclosure.

FIGS. 8A-D illustrate an example central platform assembly in accordance with aspects of the disclosure.

FIGS. 9A-M are example views of a payload release assembly and launch cart in accordance with aspects of the disclosure.

FIGS. 10A-Q illustrate examples of a launch cart and a payload release system in accordance with aspects of the technology.

FIGS. 11A-E illustrate an example of an overall launch process in accordance with aspects of the disclosure.

FIGS. 12A-E illustrates fill and launch stages in accordance with aspects of the disclosure.

FIG. 13 illustrates a launch cart in accordance with aspects of the disclosure.

FIG. 14 illustrates a control system in accordance with aspects of the disclosure.

FIG. 15 is an example flow diagram in accordance with aspects of the disclosure.

FIG. 16 is another example flow diagram in accordance with aspects of the disclosure.

FIG. 17 is a further example flow diagram in accordance with aspects of the disclosure.

### DETAILED DESCRIPTION

### Overview

The technology relates to launching lighter-than air HAPs, such as balloons configured for operation in the stratosphere. As an example, a typical balloon may include a balloon envelope having a top plate and a base plate, a plurality of tendons between the top plate and the base plate, and a payload such as to provide telecommunications (e.g., 4G, LTE, 5G, etc.) and/or other services. As noted above, it can be challenging to inflate and launch a balloon. This is especially true for large balloons (e.g., with an envelope length of 20-35 meters or longer, an envelope width of 5-15 meters or more, and/or a gas fill volume on the order of 15,000-25,000 mols or more) in windy conditions. Various equipment can be used to aid the process. For instance, a specialized release assembly may hold the HAP during inflation. Wind shields and launch towers can also be used to protect the envelope and payload. In some configurations, a specialized launch rig (LR) may be used to fill and launch the HAP in a vertical arrangement. A top fill method may be employed that involves concurrently filling the envelope in a vertical orientation while raising the assembly to launch height.

As an example, the specialized launch rig may include a rotational support structure surrounding an interior space configured for inflating and launching of balloons in a vertical arrangement. The support structure may include a series of vertical supports affixed to one or more base support elements, which may extend upward at least 75-125 feet. The base support elements are mounted on a circular or arcuate track, so that the launch rig may be reoriented as needed to accommodate varying wind directions, for instance up to 360° or continuously. Retractable wind blocks may be panels formed of fabric sections that can be raised or lowered via winches, which may be actuated by hydraulics, electric motors, or other actuators. Horizontal spar members attach to the vertical supports provide rigidity. In one configuration, the vertical supports and wind blocks form a partially open enclosure. The enclosure may be at least 50% enclosed. In some examples, the enclosure may be up to 60-75% enclosed or more. The open area permits a HAP launch module to be moved into and out of the support structure for inflating and launching.

The wind blocks and vertical supports are able to transfer large forces from the wind to the base support elements and other ground-contacting components. For instance, torque tube members of the base support elements are able to transfer the load forces to the foundation and other components arranged along the track. This arrangement permits filling and launching in wind conditions exceeding 20-30 mph.

The support structure may also include one or more cranes for lifting the HAP and inflating the balloon envelope. In one example, a crane assembly is mounted on one of the vertical supports so that the crane can move vertically along the length of the support, and to pivot in different directions to provide multiple degrees of freedom. A bridge assembly extends across the base of the launch rig. The bridge assembly is coupled to a central turntable and is configured to rotate in conjunction with the launch rig.

In order to assist with the lift, fill and launch of the balloon, a launch cart assembly may be arranged within the interior space of the launch rig. The launch cart assembly is able to enter and exit the launch rig via the bridge assembly. The launch cart assembly is configured to support the HAP payload during initial inflation of the envelope. A gripper assembly is removably engaged with a support member of the HAP, such as a rigid connection member coupling the envelope and the payload. Once the envelope is filled and the HAP is ready for launch, the gripper assembly is disengaged from the connection member and the HAP floats up and away from the launch rig.

A lift gas supply is provided in conjunction with the launch rig. The lift gas supply may be integrated into the support structure, including gas conduits run along or within at least one vertical support in order to reduce the likelihood of kinking of the lift gas supply line when the support structure is moved. In one example, upon securing the fill component of the HAP to the lift gas supply, lift gas then flows into the balloon envelope until the inflating is complete or the desired fill volume is reached within the balloon envelope.

The various features and subsystems of the launch rig may be electrically or hydraulically connected to a control system. Various user inputs may be included within a cab that is part of the launch rig or a separate control structure. The user inputs allow a human operator to communicate with the control system in order to control the movement and position of the crane, hydraulically and/or electromechanically rotate support structure, and raise or lower the wind blocks (panels). They also allow for starting, adjusting and stopping the fill process, crimping the fill connection, and disengaging the gripper assembly so that the HAP launches.

The launch rig may also include a data acquisition system. The data acquisition system may include various sensors arranged to detect the position/location and state of the various launch rig components, the launch cart assembly, the HAP itself, and environmental conditions such as wind speed, wind direction, pressure, humidity, temperature, etc. A control system can be employed using the received information to set the launch rig orientation, wind block status, fill rate and launch time, and to control operation of various system components to perform these operations. Sensor inputs may be used to dynamically adjust launch parameters to account for variations in weather, balloon state, or other factors.

### Example Balloon System

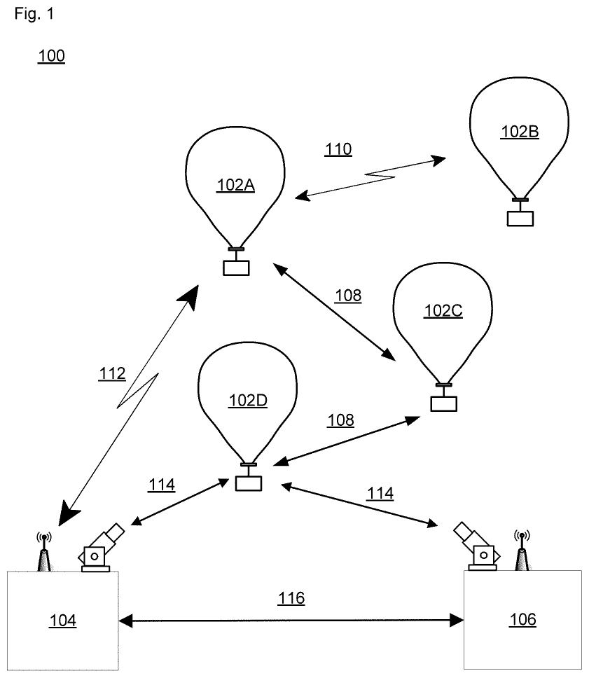

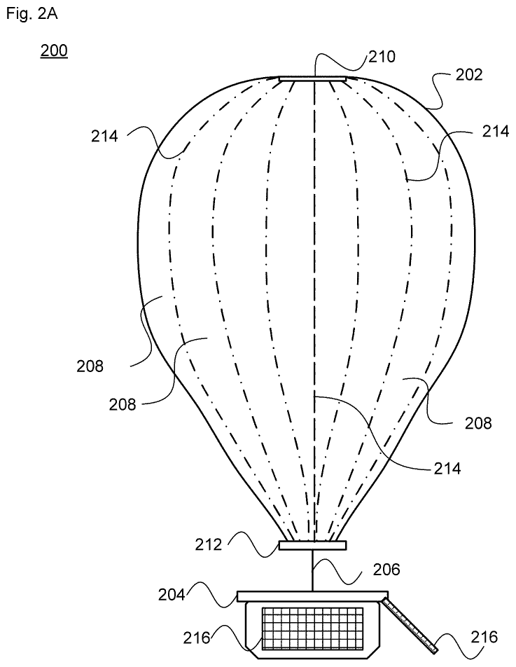

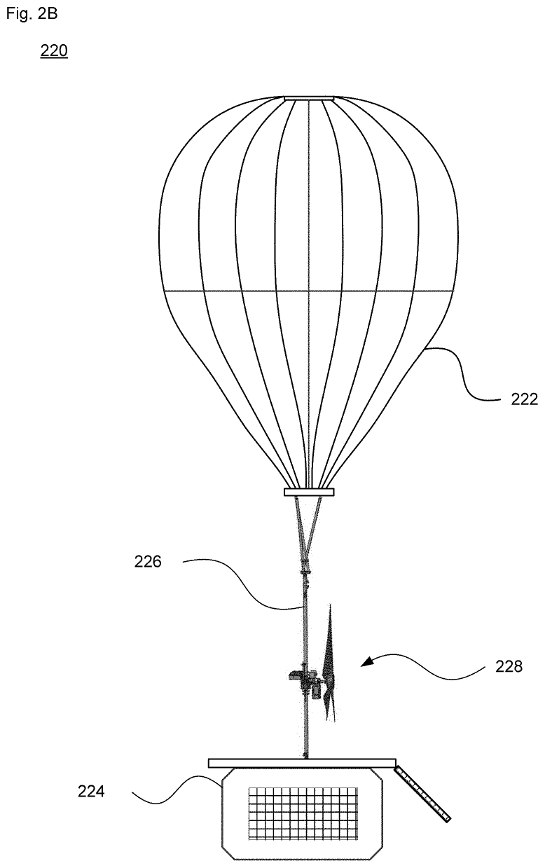

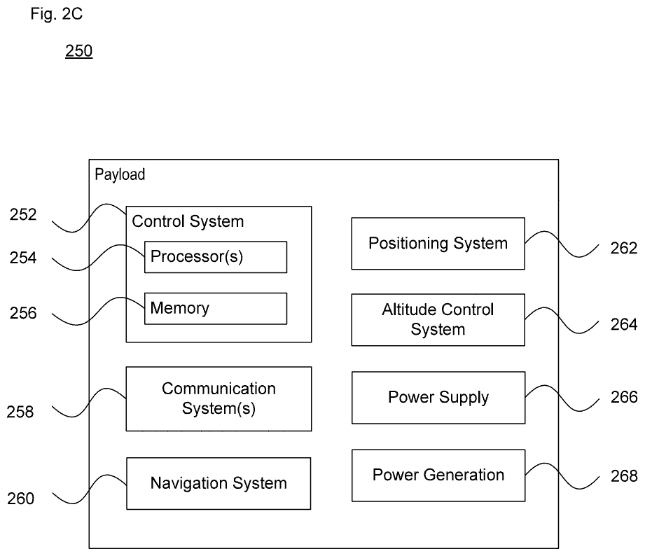

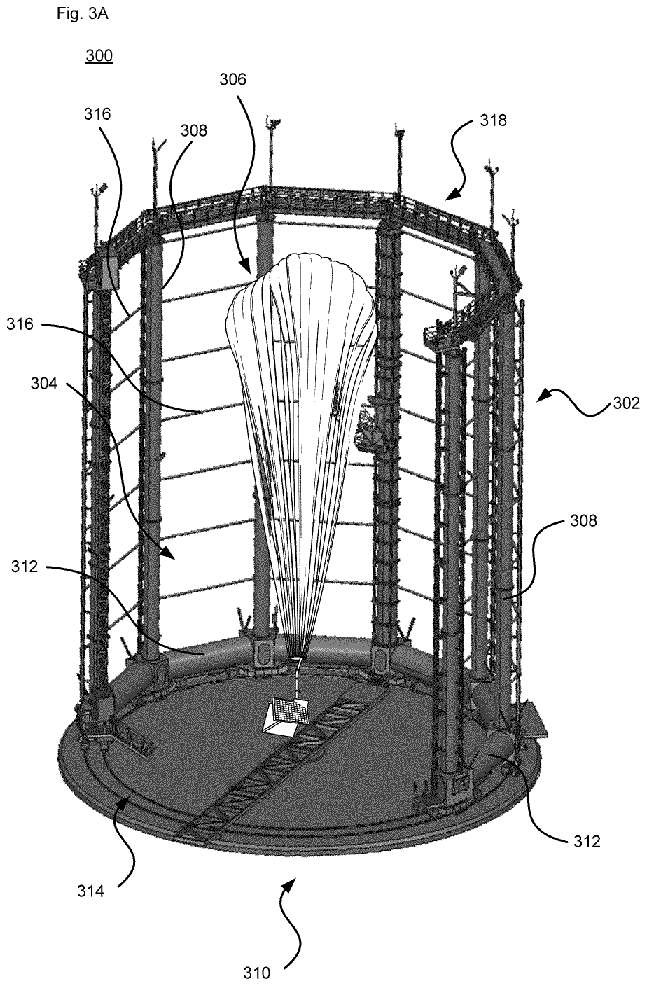

FIG. 1 depicts an example system 100 in which a fleet of balloon platforms or other lighter-than-air HAPs may be used. This example should not be considered as limiting the scope of the disclosure or usefulness of the features described herein. System 100 may be considered a HAP network. In this example, HAP network 100 includes a plurality of devices, such as balloons 102A-D as well as ground-based stations 104 and 106. Network 100 may also include a plurality of additional devices, such as various computing devices (not shown) as discussed in more detail below or other systems that may participate in the network. One example of a lighter-than-air HAP is discussed in greater detail below with reference to FIG. 2.

The devices in system 100 are configured to communicate with one another. As an example, the balloons may include communication links 108 and/or 110 in order to facilitate intra-balloon network communications. By way of example, links 110 may employ radio frequency (RF) signals (e.g., millimeter wave transmissions) while links 108 employ free-space optical transmission. Alternatively, all links may be RF, optical, or a hybrid that employs both RF and optical transmission. In this way balloons or other HAPs 102A-D may collectively function as a mesh network for data communications. At least some of the balloons may be configured for communications with ground-based stations 104 and 106 via respective links 112 and 114, which may be RF and/or optical links. In addition, the ground-based stations 304 and 306 may communicate directly via link 116, which may be a wired or wireless link.

In one scenario, a given balloon 102 may be configured to transmit an optical signal via an optical link 108. Here, the given balloon 102 may use one or more high-power light-emitting diodes (LEDs) to transmit an optical signal. Alternatively, some or all of the balloons 102 may include laser systems for free-space optical communications over the optical links 108. Other types of free-space communication are possible. Further, in order to receive an optical signal from another balloon via an optical link 108, the balloon may include one or more optical receivers.

The balloons 102 may also utilize one or more of various RF air-interface protocols for communication with ground-based stations via respective communication links. For instance, some or all of balloons 102A-D may be configured to communicate with ground-based stations 104 and 106 via RF links 112 using various protocols described in IEEE 802.11 (including any of the IEEE 802.11 revisions), cellular protocols such as GSM, CDMA, UMTS, EV-DO, WiMAX, and/or LTE, 5G and/or one or more proprietary protocols developed for long distance communication, among other possibilities.

The balloons or other lighter-than-air platforms of FIG. 1 may be high-altitude platforms that are deployed in the stratosphere. As an example, in a high altitude HAP network, the balloons may generally be configured to operate at stratospheric altitudes, e.g., between 50,000 ft and 90,000 ft or more or less, in order to limit the balloons' exposure to high winds and interference with commercial airplane flights. In order for the HAPs to provide desired coverage in the stratosphere, where winds may affect the locations of the various balloons in an asymmetrical or otherwise variable manner, the balloons may be configured to move latitudinally and/or longitudinally (transversely) by adjusting their respective altitudes, such that the wind carries the respective balloons to the respectively desired locations. Lateral propulsion may also be employed to affect a balloon's path of travel or to maintain time “on station” over a particular region.

### Example Balloon

FIG. 2A is an example balloon 200, which may represent any of the balloons 102 of network 100. As shown, the balloon 200 includes an envelope 202 and a payload (e.g., a flight capsule) 204 connected to the envelope by a connection member 206 such as a down-connect or a tether. The balloon 200 may be configured, e.g., as a superpressure balloon and include one or more ballonets (not shown) to control buoyancy.

In a superpressure or other balloon arrangement, the envelope 202 may be formed from a plurality of gores 208 sealed to one another. An upper portion of the envelope 202 has an apex section configured for connection to an apex (or top) load ring or plate 210, and a lower portion having a base section configured for connection to a base load ring or plate 212 positioned at the bottom of the balloon envelope. Tendons (e.g., webbing or load tape) 214 are shown running longitudinally from the apex load ring 210 to the base load ring 212. The tendons are configured to provide strength to the gores and to help the envelope 202 withstand the load created by the pressurized gas within the envelope when the balloon is in use. There may be a 1:1 correspondence between the number of gores and the number of tendons. Alternatively, there may be more (or less) tendons than gores.

The envelope 202 may take various shapes and forms. For instance, the envelope 202 may be made of materials such as polyethylene, mylar, FEP, rubber, latex or other thin film materials or composite laminates of those materials with fiber reinforcements imbedded inside or outside. Other materials or combinations thereof or laminations may also be employed to deliver required strength, gas barrier, RF and thermal properties. Furthermore, the shape and size of the envelope 202 may vary depending upon the particular implementation. Additionally, the envelope 202 may be filled with different types of gases, such as air, helium and/or hydrogen. Other types of gases, and combinations thereof, are possible as well. Shapes may include typical balloon shapes like spheres and “pumpkins”, or aerodynamic shapes that are symmetric, provide shaped lift, or are changeable in shape. Lift may come from lift gasses (e.g., helium, hydrogen), electrostatic charging of conductive surfaces, aerodynamic lift (wing shapes), air moving devices (propellers, wings, electrostatic propulsion, etc.) or any hybrid combination of lifting techniques. One or more solar panels 216 may be arranged on or extending from the chassis of the payload 204, for instance to provide power to the components of the payload during daylight hours, and to recharge batteries of the payload.

As noted above, the payload of balloon may be affixed to the envelope by a connection member, for instance a cable or other tether, or a rigid down-connect. FIG. 2B illustrates another example of a balloon 220 with a rigid connection member and a lateral propulsion system, which may represent any of the balloons of FIG. 1. As shown, the example 220 includes an envelope 222, a payload 224 and a down connect member 226 disposed between the envelope and the payload. Cables or other wiring between the payload and the envelope may be run within or otherwise along the down connect member. As with payload 204, one or more solar panel assemblies may be coupled to the payload 224 or another part of the balloon platform. The payload and the solar panel assemblies may be configured to rotate about the down connect member 226 (e.g., up to 360° rotation), for instance to align the solar panel assemblies with the sun to maximize power generation. Example 220 also illustrates a lateral propulsion system 228 having a propeller assembly. The propeller assembly is configured to cause the balloon to move in a desired lateral direction, for instance to arrive at a desired location or to remain on station for an extended period of time. While this example of the lateral propulsion system 228 is one possibility, the location could also be any other location that provides the desired thrust vector.

FIG. 2C illustrates one example 250 of payload 204 or 224. As shown, the payload may include a computer system such as control system 252, having one or more processors 254 and on-board data storage in memory 256. The payload 258 may also include various other types of equipment and systems to provide a number of different functions. For example, the payload 204 may include optical and/or RF communication systems 258, a navigation system 260, a positioning system 262, an altitude control system 264, a power supply 266 to supply power to various components of the payload 204, and a power generation system 268, which may include solar panels as shown in FIG. 2A or 2B.

### Example Launch Assembly

### Launch Rig Support Structure

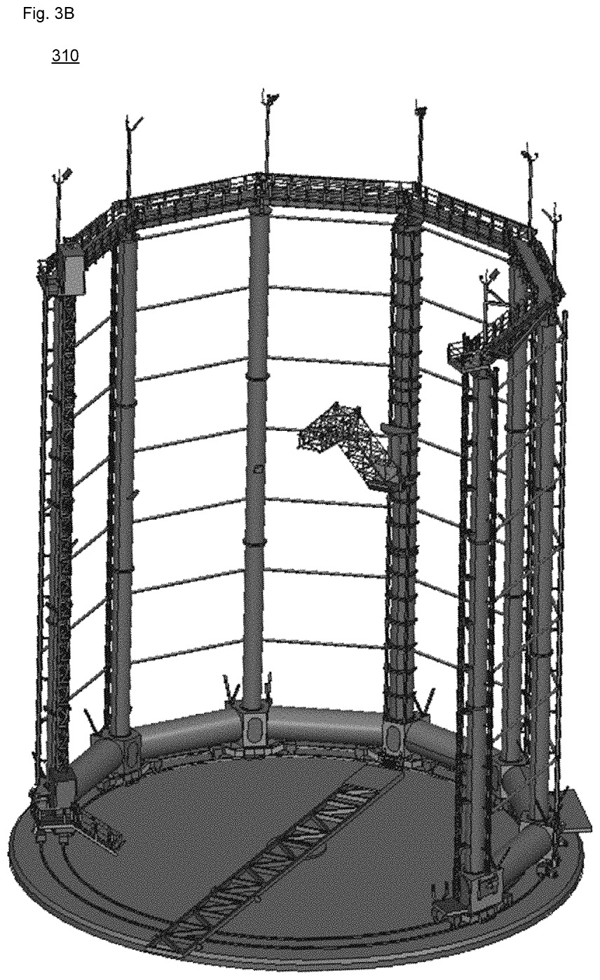

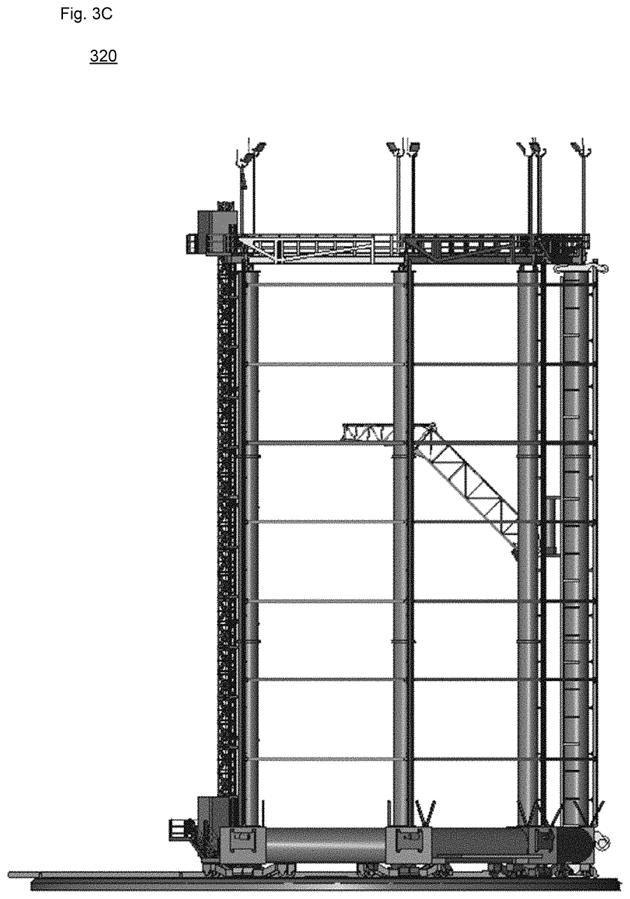

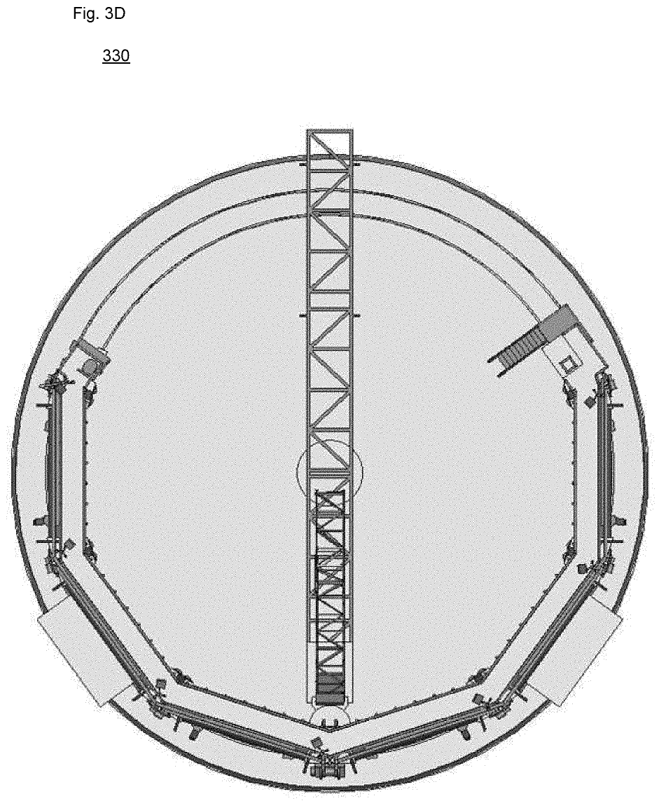

As shown in FIG. 3A, an example launch rig 300 includes a support structure 302 surrounding an interior space 304 configured for inflating and launching of HAPs such as balloon 306. In one example, the support structure 302 may be approximately 110-150 feet high and 80-120 feet wide. The support structure 300 may include a series of vertical supports 308 arranged in a circular or arcuate shape around a base 310. As shown, the vertical supports 308 are affixed to a set of base members (“torque tubes”) 312. The base members 312 rest on a track 314 of the base 310. A set of vertically aligned lateral support beams 316 couple each adjacent pair of vertical supports 308. As shown, a catwalk 318 may be disposed along a top region of the support structure 302 of the launch rig 300. FIGS. 3C-D illustrate views of the launch rig 300 with the balloon 306 omitted for clarity.

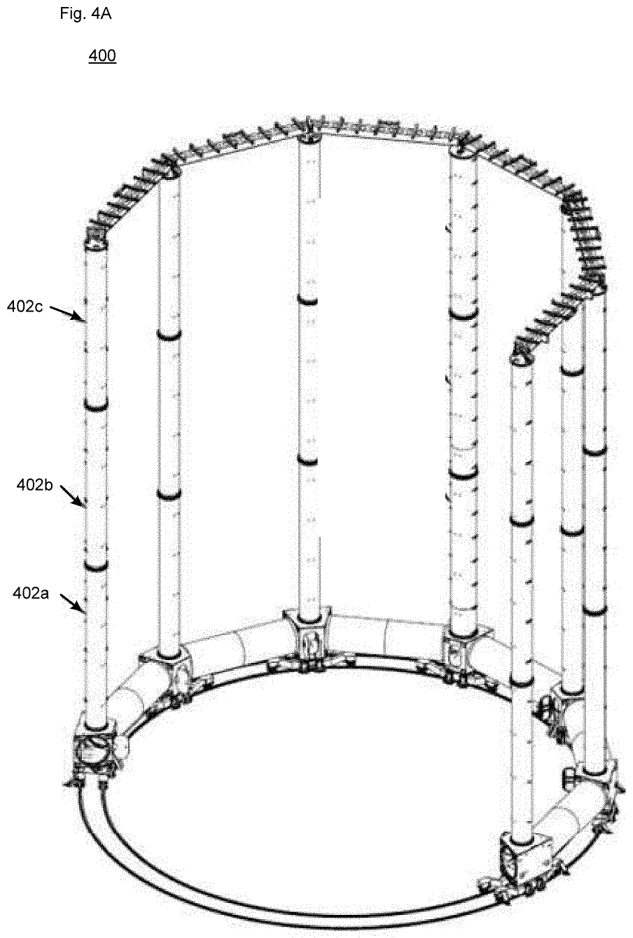

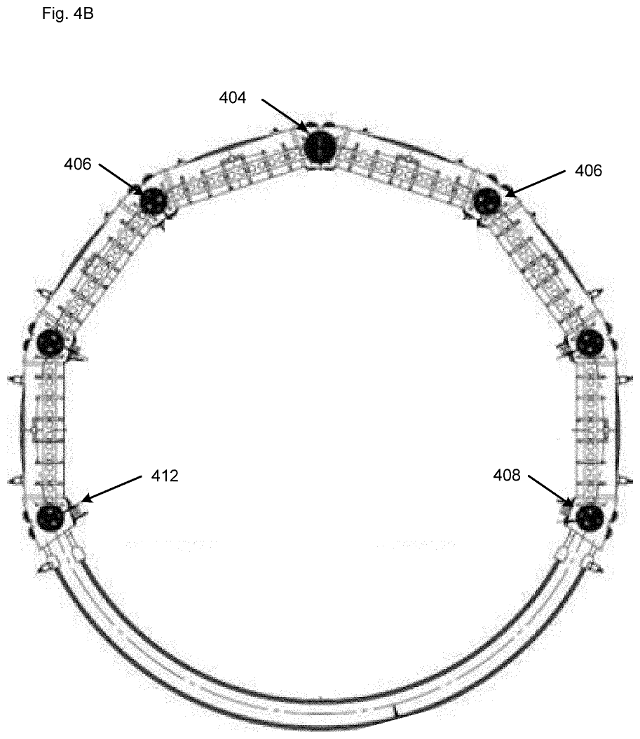

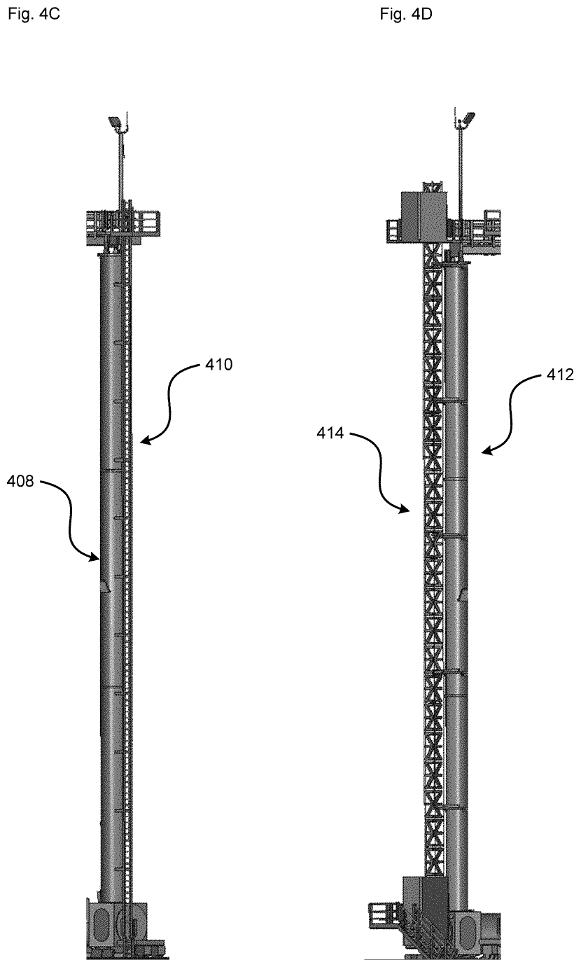

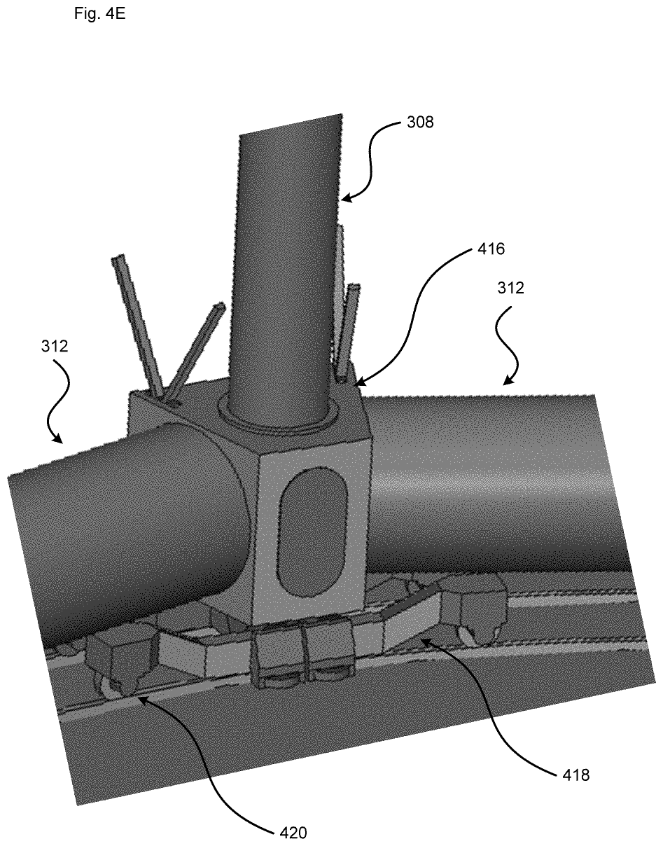

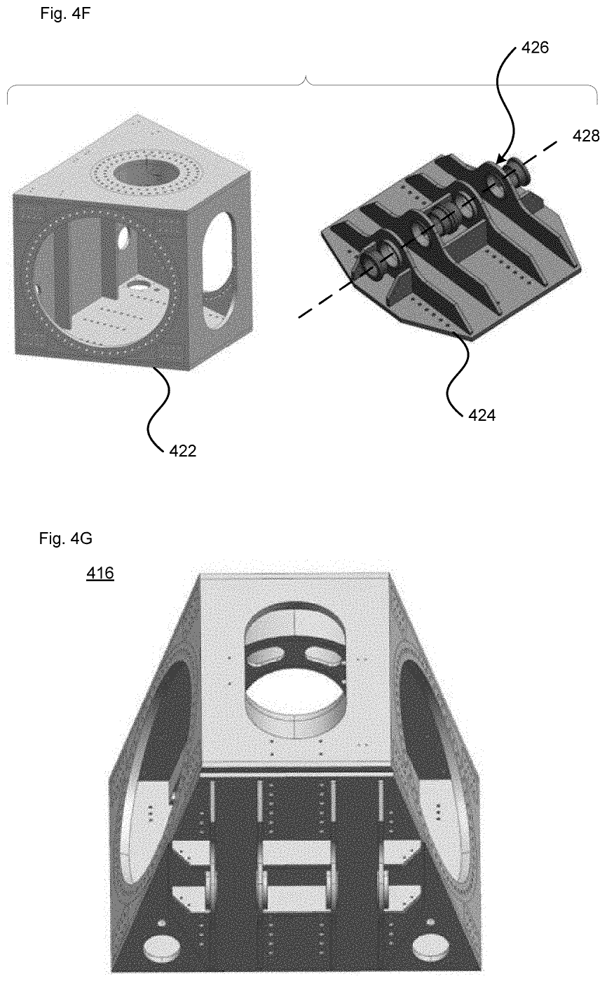

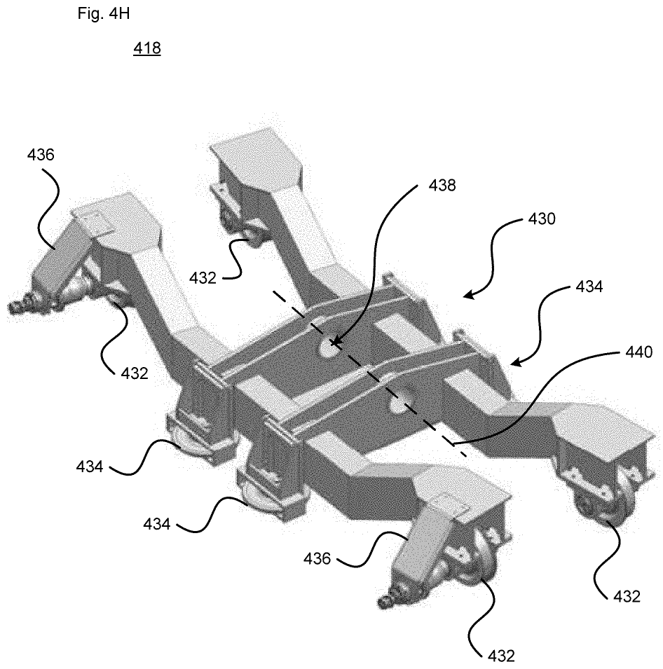

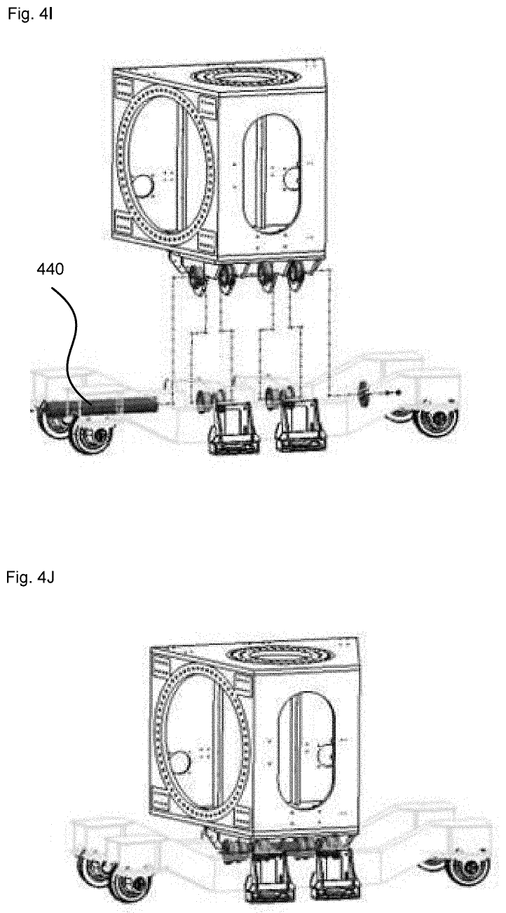

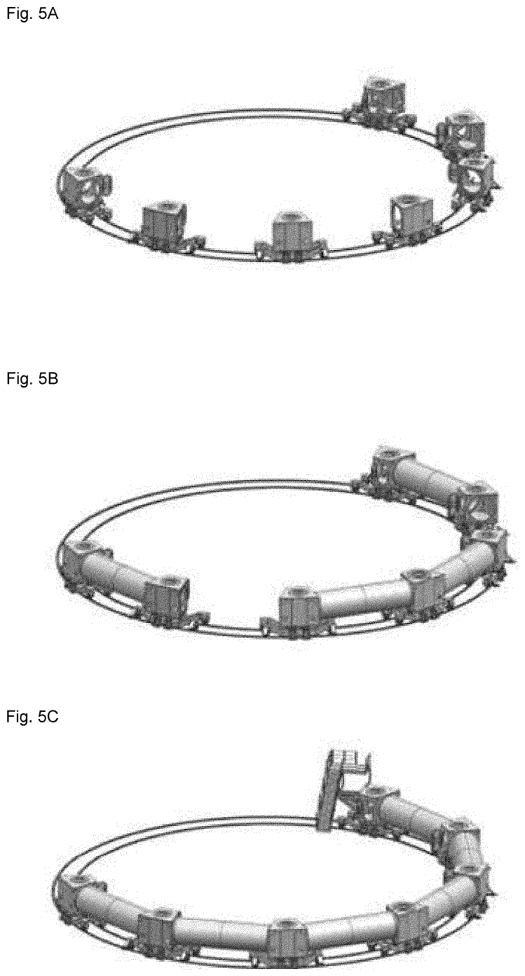

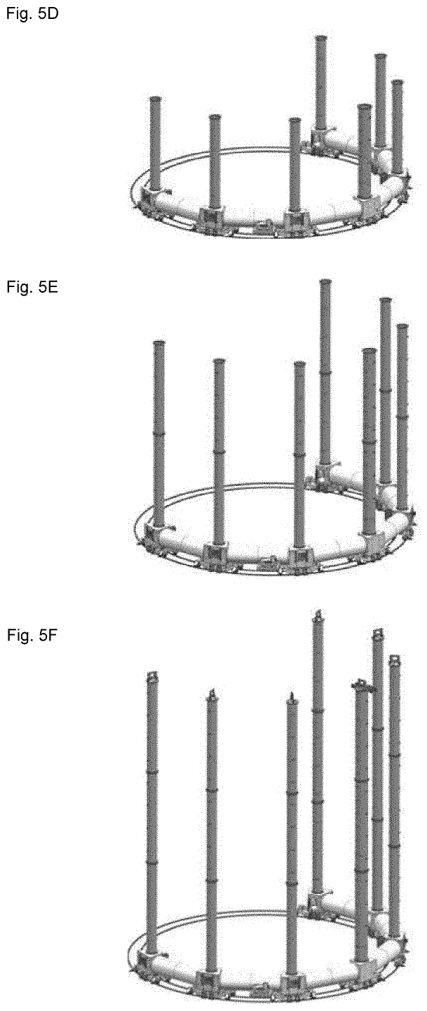

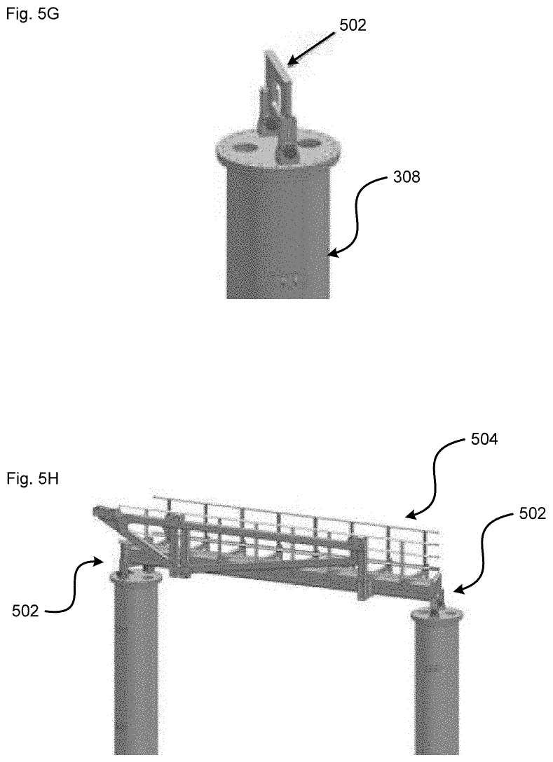

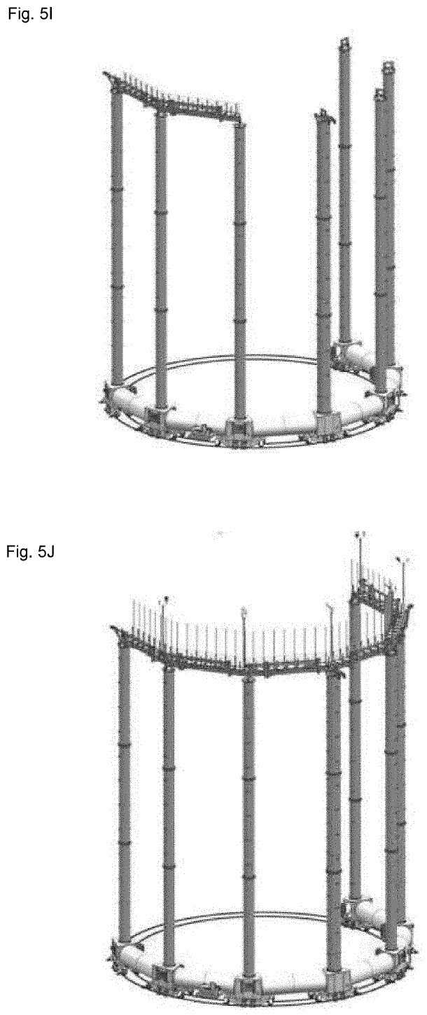

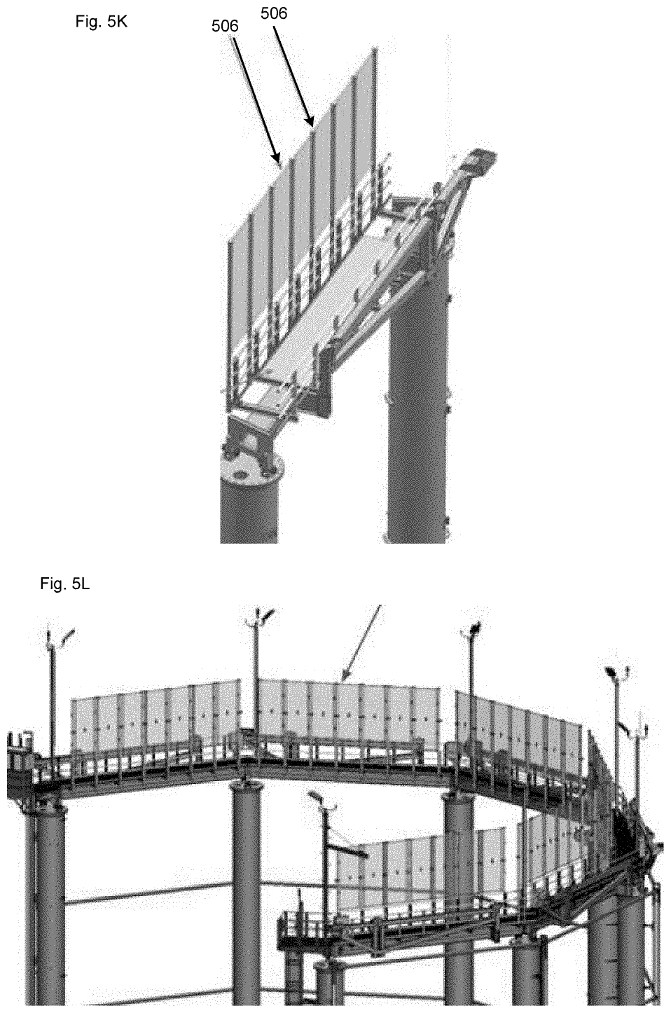

As shown in view 400 of FIG. 4A, the vertical supports may each be comprised of multiple columns, such as sections 402a, 402b and 402c. Electrical conduits and other utilities (e.g., gas lines) may be run vertically within the one or more of the vertical supports. As shown in the top-down view of FIG. 4B, the vertical supports may be tubular in shape. In one example, the vertical supports are tubes having a diameter on the order of 40-55 inches. However, one or more of the vertical supports may have different diameters. For instance, support 404 may have a larger diameter than the other supports 404, for instance to accommodate a lifting assembly (see FIGS. 5A-B). In an example shown in FIG. 4C, a first vertical support 408 may have a ladder 410, and in an example shown in FIG. 4D, a second vertical support 412 may have an elevator 414, such as to provide service access to the upper sections of the support structure.

Returning to FIG. 3A, as shown the base members 312 may also be tubular in shape. In one example, the base members are tubes having a diameter on the order of 60-84 inches, and may be configured to accommodate electrical, hydraulic and other utility conduits. FIG. 4E illustrates a vertical support coupled to a pair of adjacent base members via a wedge assembly 416, which can serve as an equipment housing in addition to a connection between the vertical support and the base member(s). The wedge assembly 416 is connected to a moveable “bogie” 418, which is configured to rotate the support structure by movement along rails 420. Each bogie may be actuated by a drivetrain, such as a hydraulic motor with an integrated parking brake. The drivetrains may be configured to rotate the support structure at speeds up to 1.0-2.0 mph or more.

As seen in the exploded view of FIG. 4F, the wedge assembly 416 includes a wedge body 422 that couples to the vertical support and the base member(s). The interior of the wedge body 422 is generally open, for instance to run electrical and hydraulic lines. The wedge assembly 416 also includes a base plate 424, that is pivotally coupled to the bogie 418. The base plate includes a series of receptacles 426 aligned along an axis as shown by dashed line 428. FIG. 4G illustrates a view of the assembled wedge assembly.

FIG. 4H illustrates a perspective view of the bogie 418. As shown, the bogie includes a support section 430 upon which the wedge assembly rests. Drive wheels 432 are disposed on either end of the support section 430. One or more guide rollers 434 are positioned on either side of the support section 430. Torque arms 436 may be coupled to one or more of the drive wheels, for instance when those drive wheels are connected to a drivetrain (not shown). One or more of the bogies of the launch rig may be driven using hydraulic drivetrains having a motor, brake and gearbox assembly. As shown, the support section 430 includes a set of receptacles 438 aligned along an axis indicated by dashed line 440. A wedge pin 440 is inserted through the receptacles 426 and 438, as shown in FIG. 4I, and FIG. 4J illustrates the bogie and wedge assembly connected together.

During installation of the base ring structure, the bogie/wedge assembly modules can be positioned on the rails, and then attached to the base members. An example of such an installation is shown in the views of FIGS. 5A-C. Once the base ring structure is complete, the vertical supports can be assembled. An example of this assembly is shown in the views of FIGS. 5D-F. A catwalk assembly can then be installed atop the vertical supports. For instance, as shown in FIG. 5G, a center junction plate 502 is attached to the top of a vertical support. Catwalk sections 504 can then be affixed to the center junction plates, as seen in FIG. 5H. FIGS. 5I and 5J illustrate further assembly steps for catwalks on the support structure. As shown in FIG. 5K, crown panels 506 may be installed along one side of the catwalk. The crown panels can be used to mitigate wind shear or otherwise reduce wind speeds within the launch rig support structure. FIG. 5L illustrates a view in which crown panels are installed along all of the catwalks of the support structure. Valances may be added between the main structure and ground and between other gaps to further prevent wind inside the system. The interior of the main structure, tubes, wedges may be used to route utilities such as gas, hydraulics, electrical, and communication lines throughout the system. Openings in the wedges can be made to allow utilities to exit

### Lifting Assembly

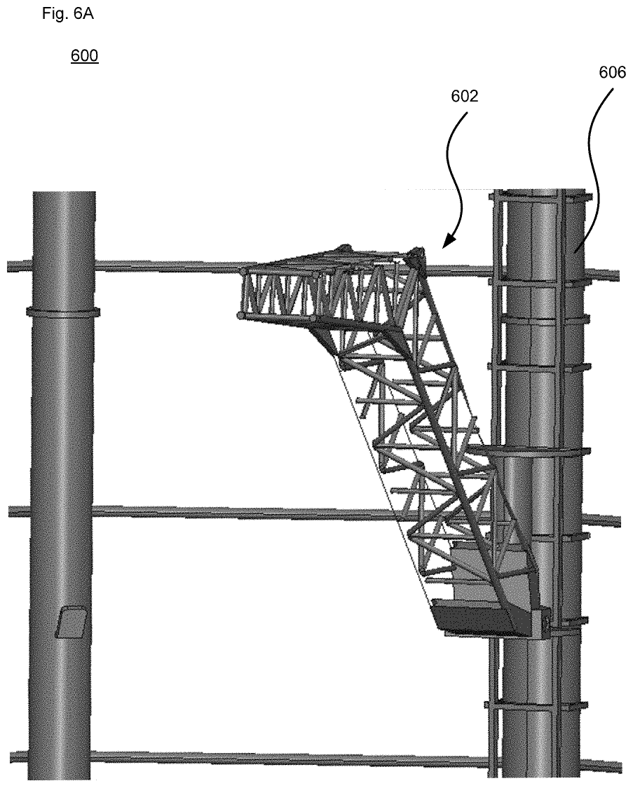

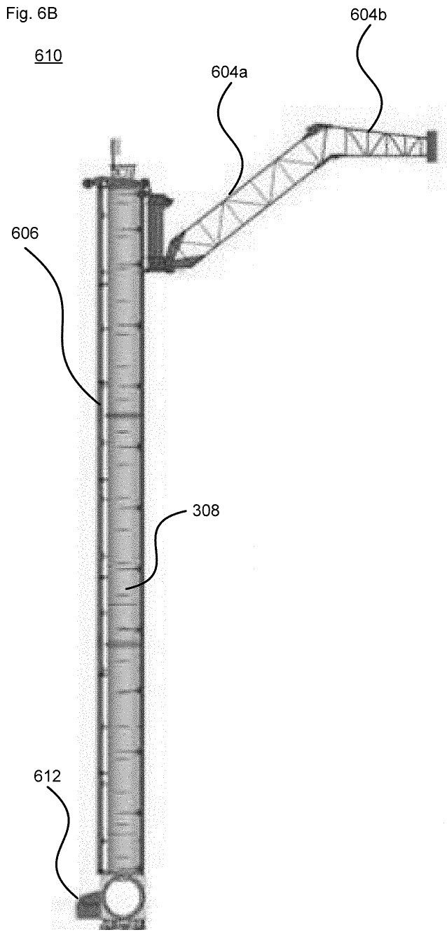

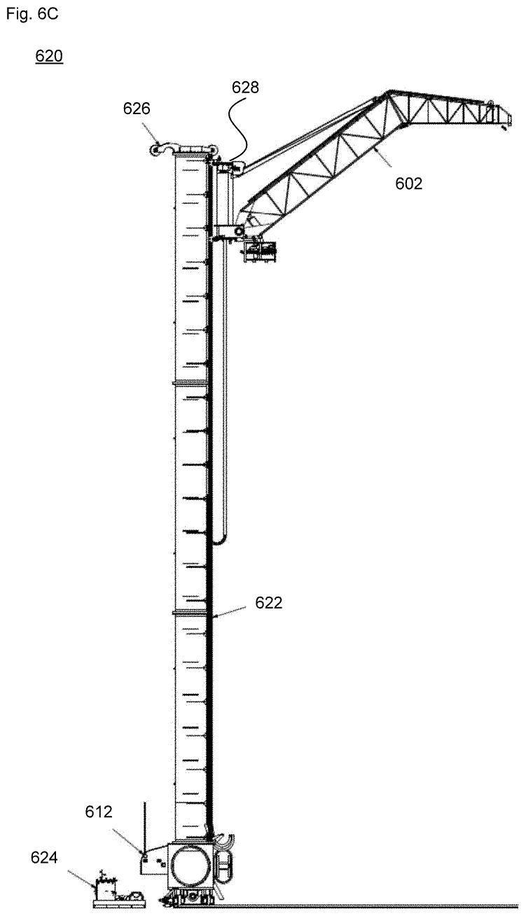

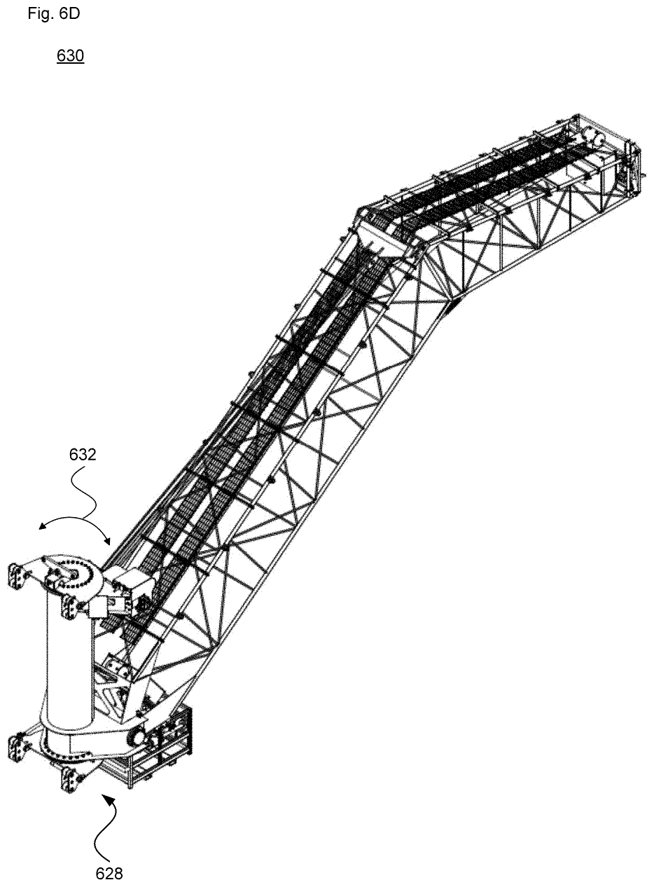

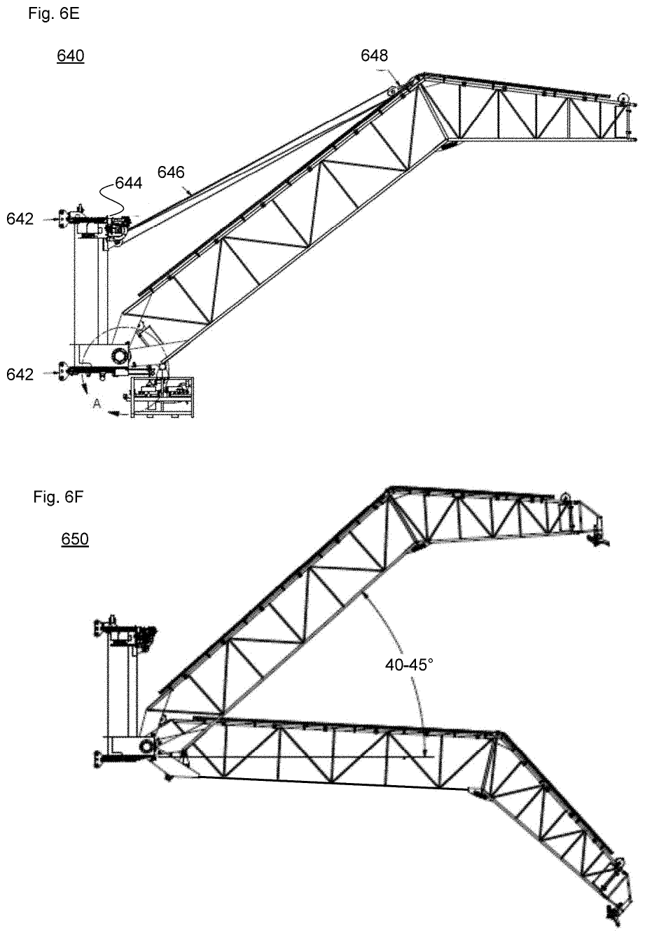

As seen in perspective view 310 of FIG. 3B and side view 320 of FIG. 3C, a lifting assembly is coupled to one of the vertical supports. As shown in views 600 of FIG. 6A and 610 of FIG. 6B, the lifting assembly may include a crane having a boom subassembly 602 including a lower boom member 604a and an upper jib member 604b coupled to a vertical elevator subassembly 606. As shown in view 610 of FIG. 6B and view 620 of FIG. 6C, the lifting assembly is configured to raise the balloon envelope from ground level to launch height via a hoist 612 and rail and yolk assembly 622. The hoist 612 may be actuated using a hydraulic tank assembly 624 (see FIG. 6C).

A top sheave assembly 626 and a slewing mechanism 628 are also shown in FIG. 6C. The top sheave assembly 626 may be used in conjunction with the hoist 612 when raising or lowering the lifting assembly. The slewing mechanism 628 provides for rotation of the lifting assembly. View 630 of FIG. 6D illustrates the boom subassembly and the slewing mechanism, where arrow 632 indicates the rotational movement of the boom subassembly. In this example, the slewing mechanism may be hydraulically or mechanically actuated. FIG. 6E illustrates a side view 640, in which it can be seen that the slewing mechanism includes rail carriage assemblies 642, which engage with rails along the vertical column 606. A shuttle assembly 646 is configured to raise and lower the boom subassembly via wire rope 646, which engages with sheeve assembly 648. View 650 of FIG. 6F shows an example of the range of vertical movement of the boom subassembly, which is on the order of 40-45°.

Adjustments are made as the envelope is filled with lift gas. A mass metering rig may be coupled to the lifting assembly. Placing the mass metering rig on the boom (or jib) minimizes gas line volume between the meter and HAP thereby enhancing fill accuracy. Example fill procedures for filling the envelope while the balloon is in a vertical arrangement are discussed further below.

According to one aspect, the lifting assembly is engineered to withstand side loading. In one scenario, the boom may be raised vertically by the elevator subassembly up to 100-120 feet or more, and provide a lateral translation of +/−40° or more. Should detected (or predicted) wind speeds exceed a threshold level of, e.g., 40-60 mph, an abort procedure may include lowering the lifting assembly either to ground level or to some other designated height.

The lifting system is configured to move in three distinct axes. The hoist moves vertically up and down the vertical column 606, translating the entire lifting assembly. The luff axis allows the jib tip to rotate upwards and downwards in reference to an axis perpendicular to the elevator motion and parallel to the ground. This enables the jib tip to reach the ground and to reach maximum height without the lifting assembly making contact with any part of the balloon envelope. Rotation of the lifting assembly about the slew axis (“slew motion”) provides for rotation about an axis parallel to the vertical column 606 to move the entire structure out of the way before balloon launch.

According to one aspect, at any point the system can go into emergency abort, in which it will automatically release the balloon before overloading the crane. At this point the lifting assembly will hoist down at an increased rate, taking both the boom/jib and balloon down to the ground where the hazard can be minimized. This may be done with a dual speed hydraulic motor, enabling “emergency descent” of the system when extra speed is required.

The lifting assembly may also house the mass metering rig as well, which hangs off the boom or jib at the bow of the structure. In one example, this rig is hung on a pivot member and thus stays level through any luff position (which is ideal for flow meter measurement accuracy). By placing the mass metering rig in this position, the machine is able to achieve higher accuracy fill amounts. For instance, by being proximally closer to the balloon entrance, the measured flow in the mass metering rig is closest to the amount of gas input into the balloon.

### Wind Block Assembly

As noted above, wind blocks can be employed to mitigate the wind's impact during fill and launch. The panels may be raised or lowered via hydraulic or mechanical winches or other actuating mechanisms integrated in spar members attached to the vertical supports. For instance, the panels can be raised prior to launch, and may be adjusted as the support structure is rotated about the rail system.

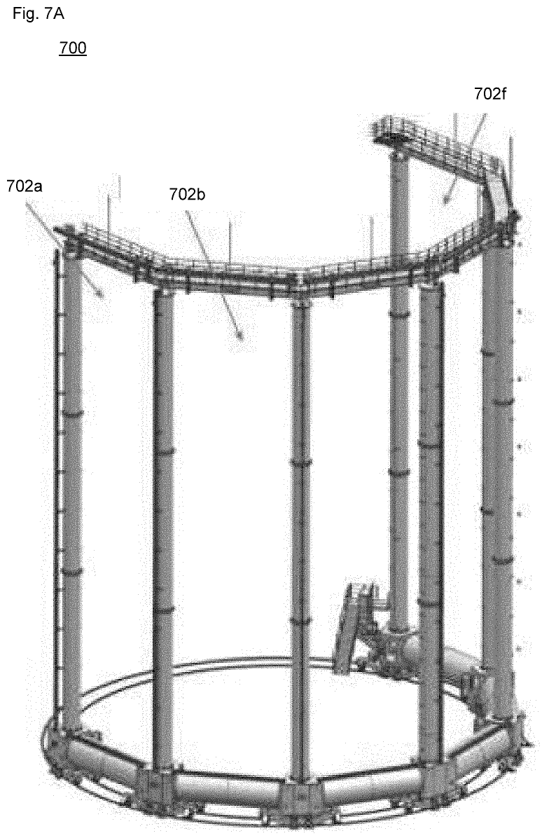

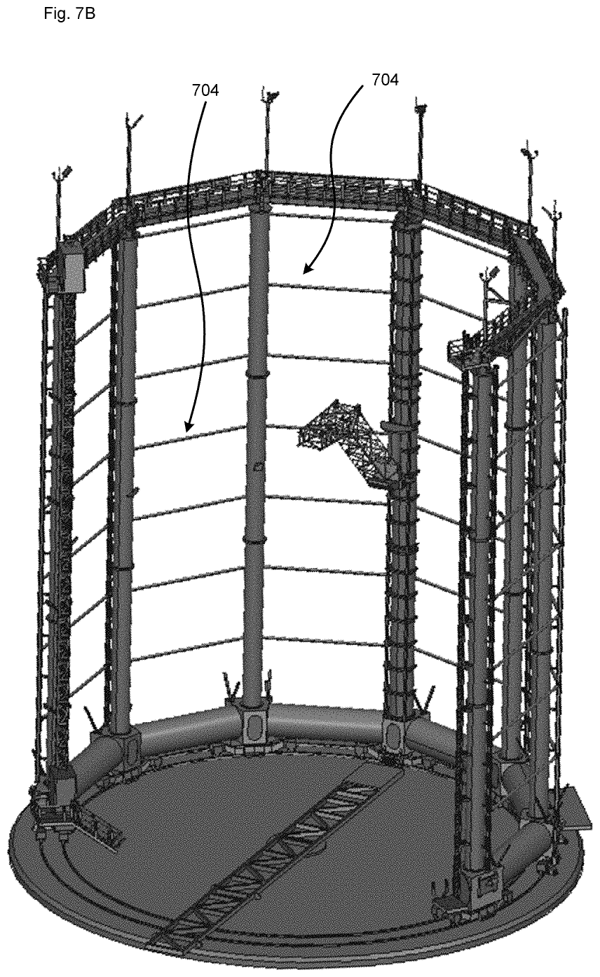

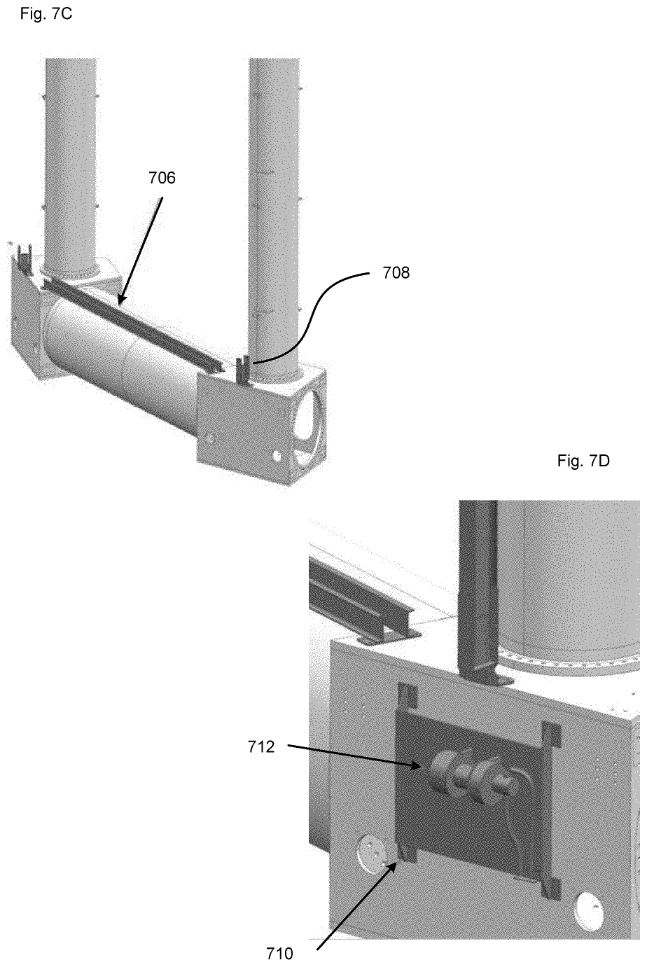

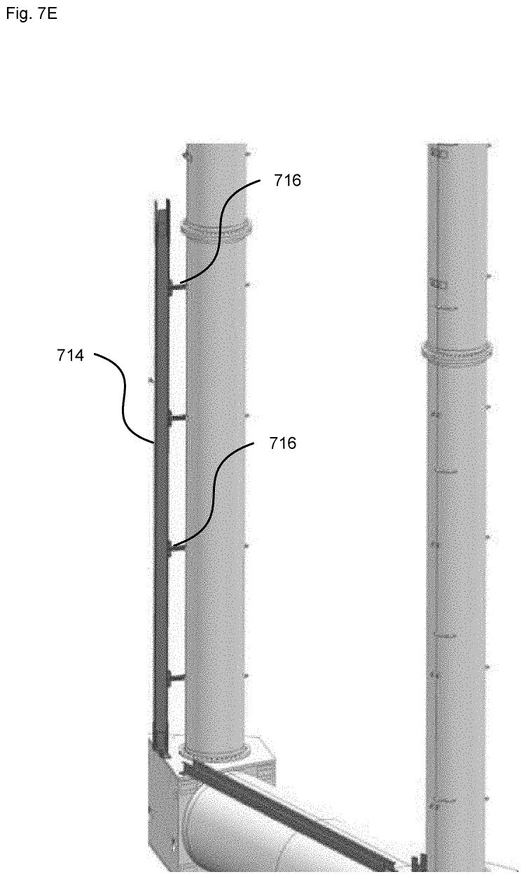

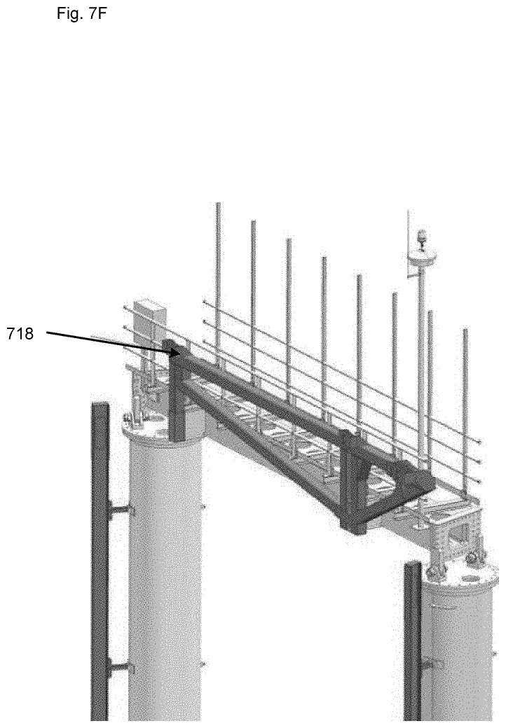

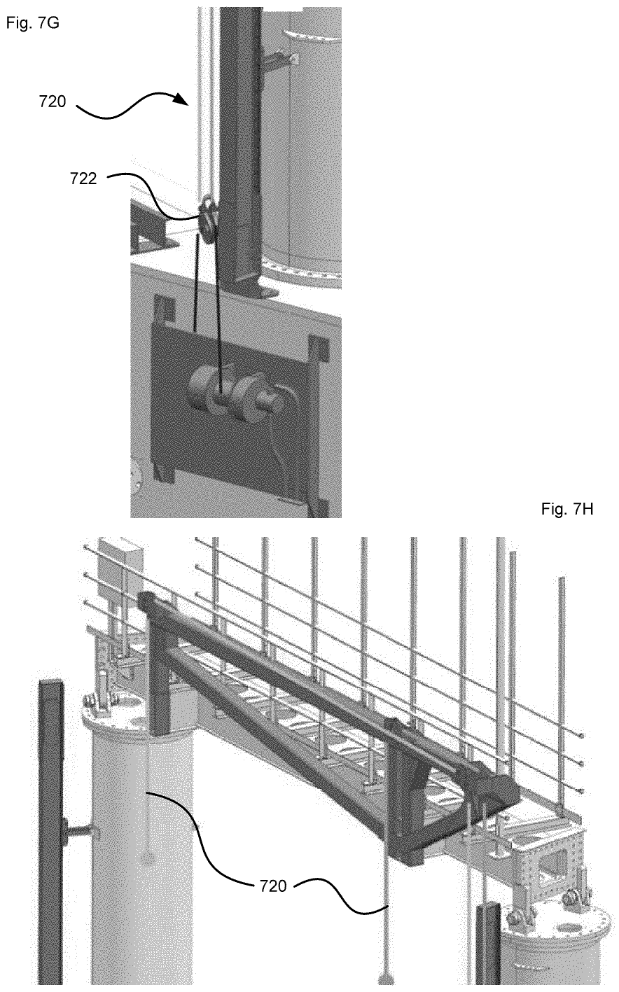

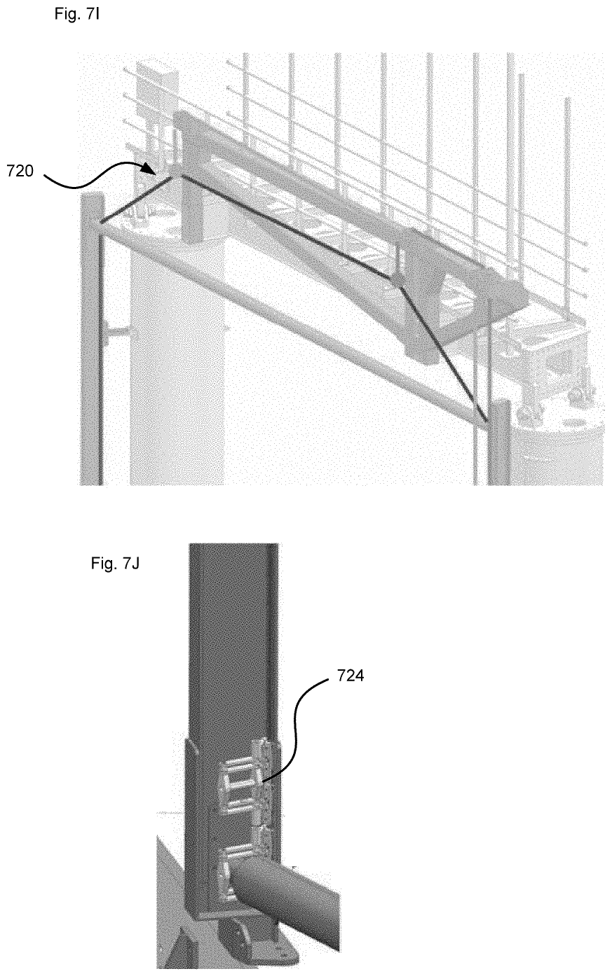

As shown in view 700 of FIG. 7A, each pair of adjacent vertical supports defines a “facet” 702, illustrated as facets 702a, 702b, . . . , 702f. A series of horizontal spars 704 is arranged across each facet. Thus, in the example of FIGS. 7A-B, there may be 6 retractable walls, each including one or more panels and one or more horizontal spar members, although there may be more or fewer facets and/or panels depending on the arrangement and height of the support structure. In one example, the support structure may be up to 150 feet high.

An example assembly process for the wind block assembly is as follows. First, a bottom rail 706 and bottom supports 708 are attached to the wedge assemblies as shown in FIG. 7C. A winch mount plate 710 and a winch 712 are affixed to the side of each wedge assembly as shown in FIG. 7D. One winch may be used per facet or for multiple facets. Vertical beams 714 are attached along each vertical support, for instance being coupled by a set of lateral links 716 extending away from the vertical supports, as shown in FIG. 7E. A davit 718 is coupled to the catwalk as shown in FIG. 7F. Once these elements are affixed to the support structure, as indicated in FIGS. 7G-I, the winch cabling (e.g., halyard) 720, pulley blocks and counterweights (not shown) are assembled. A set of travel units 724 (e.g., Harken cars) are coupled to tracks on the vertical beams, as shown in FIG. 7J. The travel units are configured to ride up and down the tracks to raise and lower the wind block panels. Then, as shown in FIG. 7K, panels 726 are installed onto the spars. The panels may be a cloth or other material that can be easily replaced if damaged.

The retractable walls may be raised and lowered hydraulically or mechanically via the winches. A control system may automatically control adjustment of the walls by actuating the winches. As noted above, the walls can be raised prior to launch, for instance before the fill process has started. Adjustments may be made depending on wind conditions (e.g., speed or direction), as well as the orientation of the launch system in relation to the wind. According to one aspect, a mechanical or a soft fuse may be used to disable the function of the panels by means of restricting the motion or opening up the walls in case of wind or another overload condition. This is to minimize the effect of wind loading on the rest of the structure and to maintain the integrity of the wind walls.

### Central Platform Assembly

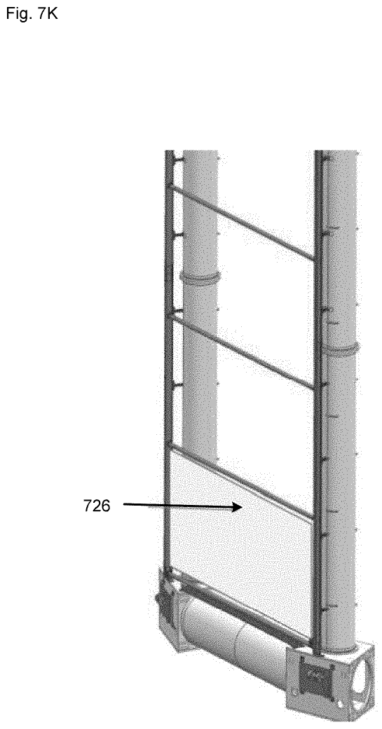

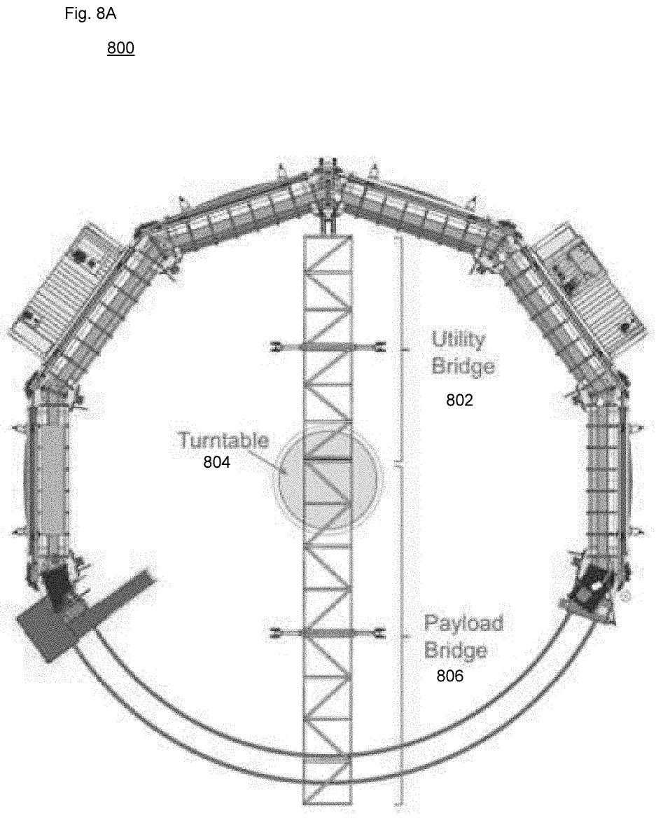

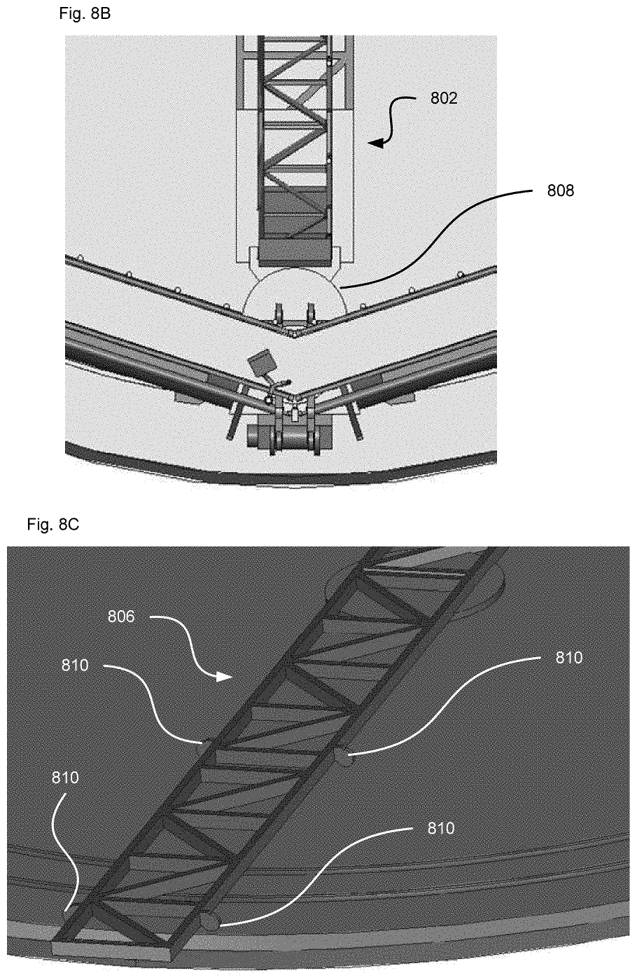

In order to enable efficient launch of the HAP, a central platform assembly is provided for loading the HAP into the launch platform and for making adjustments as the support structure is repositioned. FIG. 8A illustrates one example 800, showing that the central platform assembly includes a utility bridge 802, a central turntable 804 and a payload bridge 806. The assembly may include a single or multiple structure(s), temporarily or permanently joined together, and permanently or temporarily attached to the rest of the main launch platform structure. The central turntable 804 may be actively or passively driven to align the central platform structure with the ambient wind direction and the rest of the launch rig structure. The rotation of the structure may be restricted to any number of degrees in a clockwise or counter clockwise direction, or it may be free rotating in one or both directions.

As shown in the close-up view of FIG. 8B, the utility bridge 802 is affixed at a first end to one of the wedge assemblies via a connection 808. The utility bridge 802 is affixed at the other end to the central turntable 804. While not shown, each of the support structures may have a set of tires, casters or other wheels disposed for contact with the ground or the rails as the system rotates. The payload bridge 806 is also connected at one end to the central turntable 804. As shown in FIG. 8C, sets of wheels (e.g., casters or tires) 810 are disposed along the payload bridge 806, which are in contact with the ground as the system rotates. The turntable 804 is supported by rollers (not shown), which may interface with a circular rail disposed beneath the turntable. As shown in FIG. 8D, a platform 808 is rotatable positioned on the turntable 804.

Also shown in FIG. 8D in this example is a center pit 812, which provides an underground or a fully or partially covered area that houses the support structure for the turntable and the bridge structures, as well as some or all of utilities. Utilities ma include the lift gas, process gas, power and communication lines etc. The center pit 812 also provides a work area for maintenance and installation of these utilities and structures. The center pit 812 may also provide an area to keep the utilities protected from the natural elements as well as accidental damage.

The platform 808 may also include a carriage 814, which enables automated or manual positioning of the flight vehicle and the launch cart. A predetermined path along the bridges with one or multiple predetermined locations may be included for automation and or consistency of balloon launches. The carriage 814 may be moved along the bridges using rollers and bearings and/or wheels, to minimize the vibration on the flight vehicle. The mobility of the carriage 814 in one or both directions may be achieved through actuation (e.g., hydraulic or mechanical) or manual means. The carriage 814 may have components or features to secure the launch cart as well as features and components to guide the docking and un-docking of the launch cart. This can include, e.g., bump posts, a laser guide, etc. Thus, the carriage and its actuation enable the dynamic launching of the balloon by synchronizing the movement of the balloon, during the launch process.

### Example Payload Release Assembly

In order to lift, fill and launch the HAP, an arrangement may be provided that includes a configuration to support the HAP when it is in the launch platform. In accordance with aspects of the technology, a launch cart supports the HAP and a payload release assembly secures the HAP during lift and fill. The launch cart may be moved onto the central platform assembly via the payload bridge, for instance being loaded onto the payload bridge by a forklift.

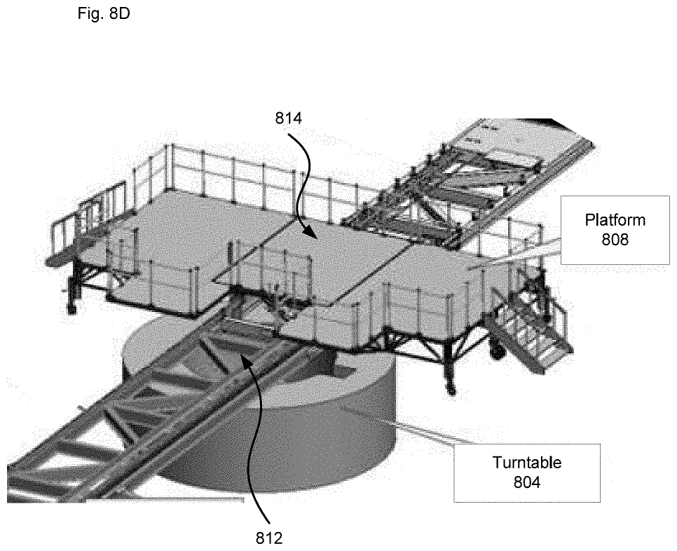

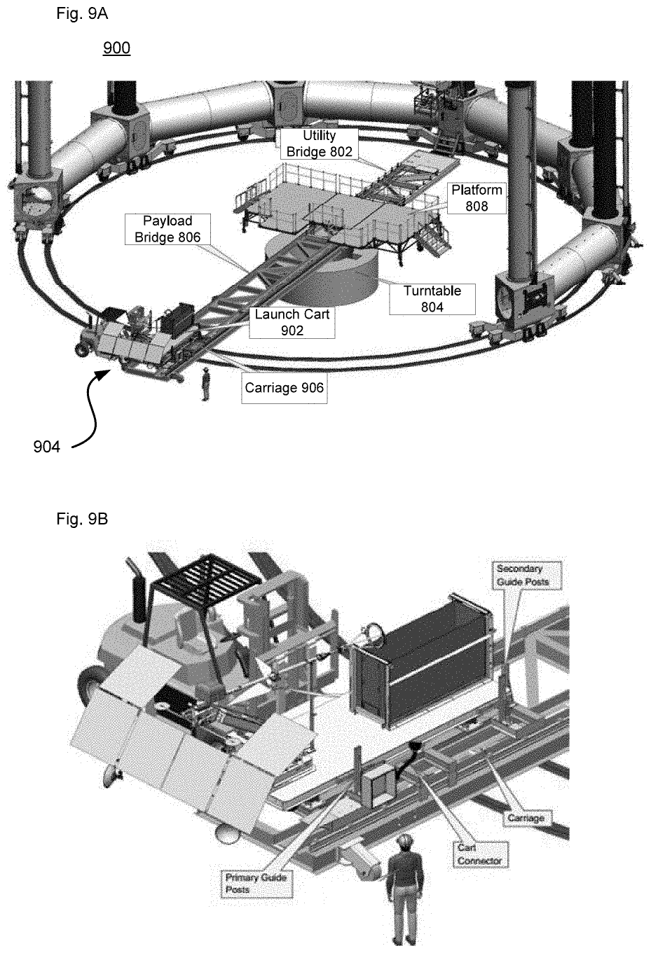

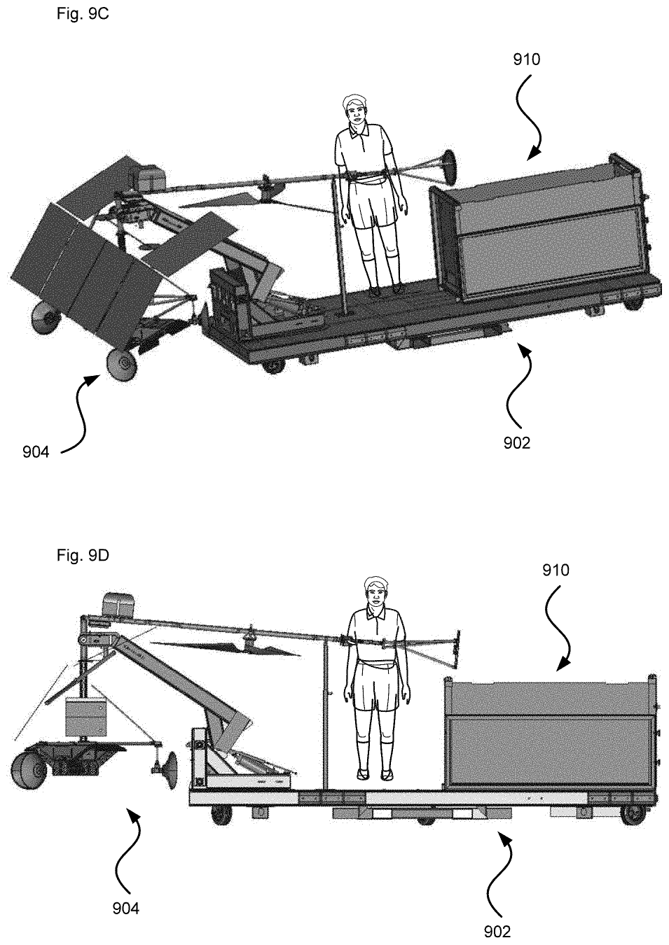

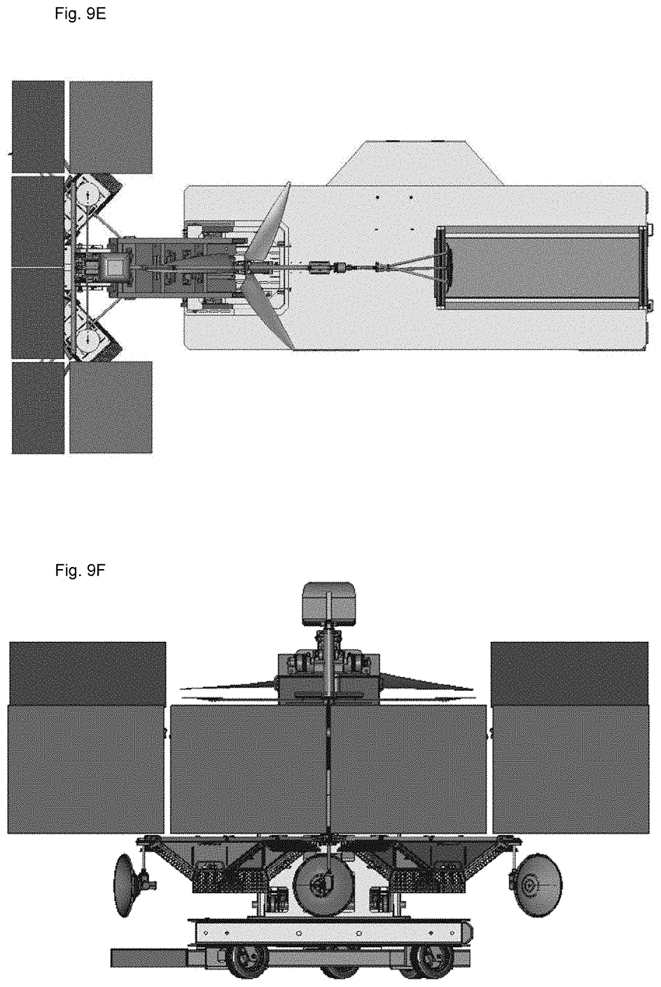

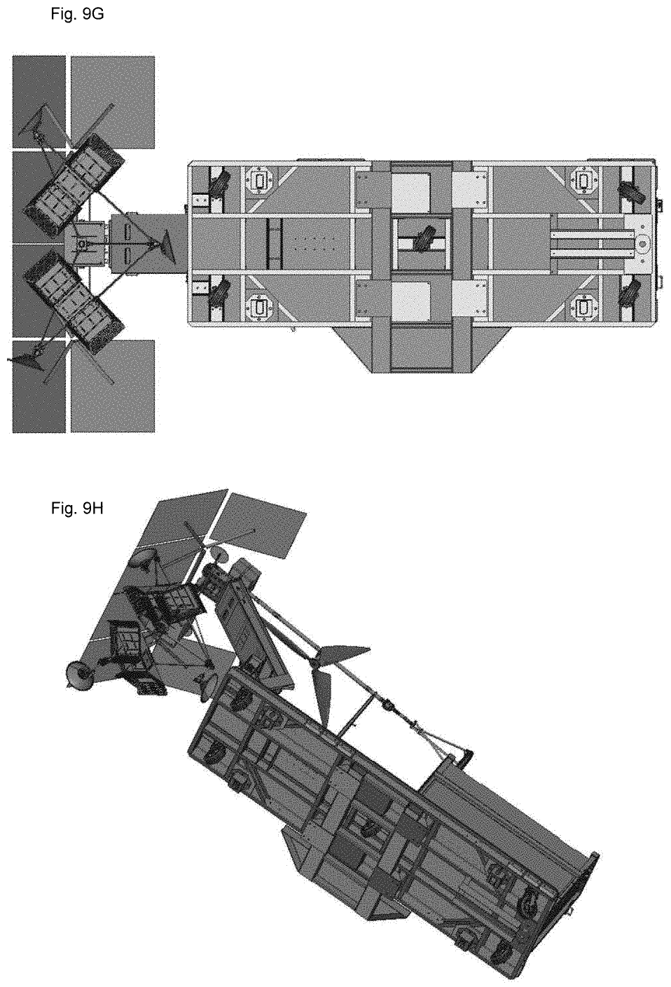

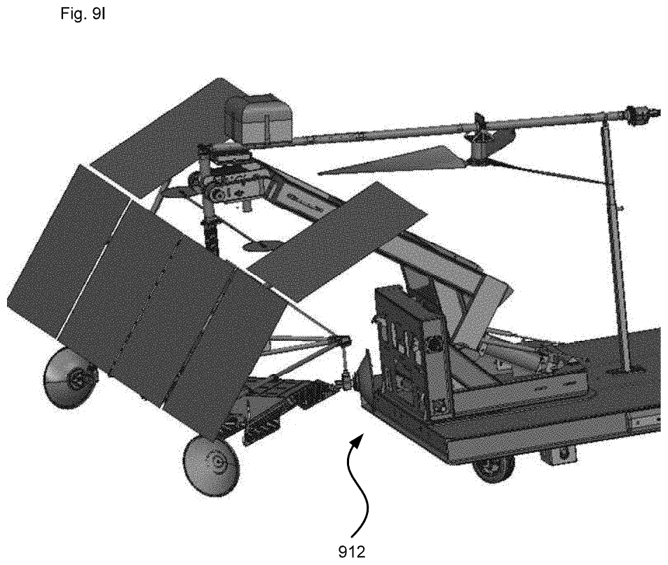

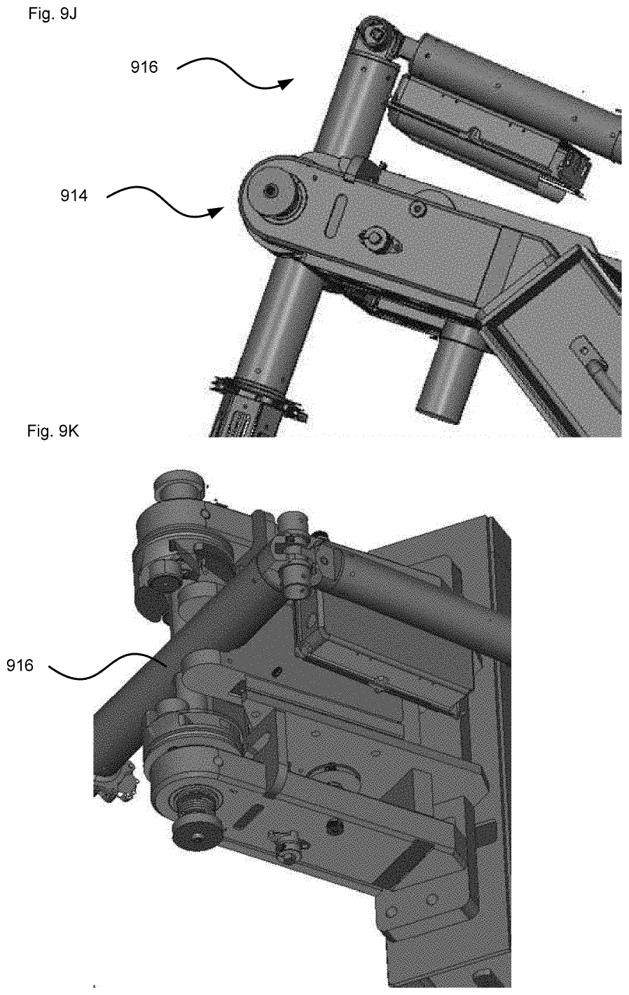

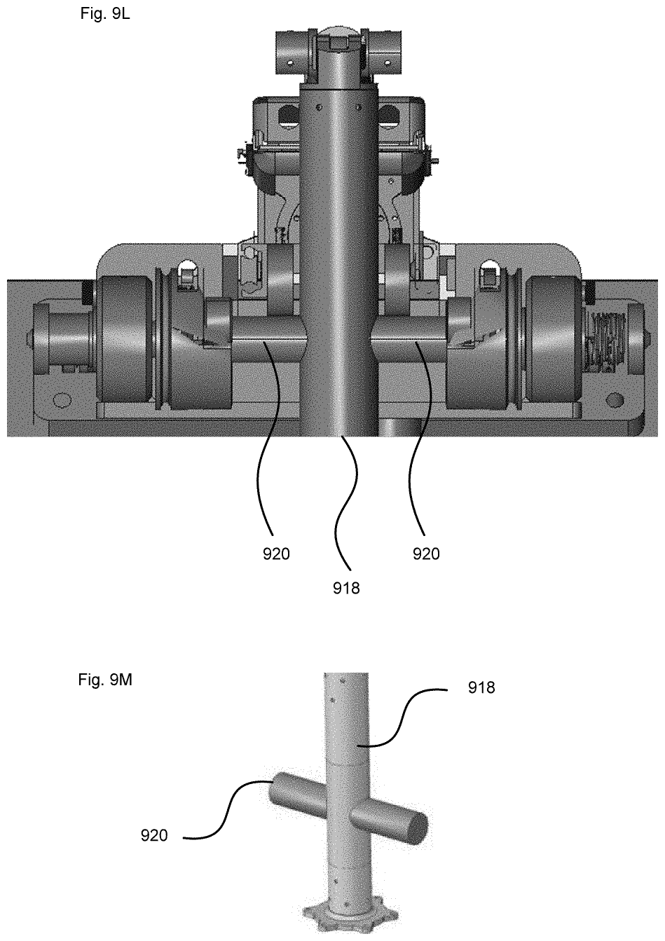

FIG. 9A illustrates an example arrangement 900, in which a launch cart 902 supports a payload (e.g., a lighter-than-air balloon assembly) 904 on a carriage 906. The payload is transported along the payload bridge 806 until reaching the platform 808. The platform 808 is used as a work platform and supports the work operations of personnel. Because the payload bridge is configured to rotate about the turntable as the support structure is rotated, the payload can be readied for launch no matter what orientation the support structure is in. FIG. 9B illustrates a close up view of the payload bridge as the launch cart with payload is being loaded onto it by, e.g., a forklift. As shown, there may be primary and secondary guide posts, and a cart connector used to guide and position the carriage on the payload bridge. For instance, the cart may contact the primary guide post(s) and then be shifted sideways to contact the secondary guide post(s). Once properly positioned, the cart can be moved onto the central platform via the payload bridge.

The launch cart, including the payload release assembly, are configured to hold the HAP during a vertical filling process (discussed further below), without directly holding the balloon envelope. This avoids stress on the envelope, minimizing the likelihood of damage to it. In one example, the payload release assembly provides a single release point along a down-connect or tether element of the HAP between the balloon envelope and the payload.

FIGS. 9C-H illustrate views of the payload 904 and launch cart 902. In this example, a box or other housing 910 stores the uninflated balloon (not shown). The payload release assembly is configured to secure the payload until the balloon envelope has reached a certain fill status and the payload is ready to be released. This reduces the likelihood that the payload will collide with the launch cart, platform, support structure or ground after the HAP is released during a launch.

FIG. 9I illustrates a view of the payload coupled to the launch cart via a payload release assembly 912. As shown, the payload release assembly is rigidly affixed to the launch cart; however, in certain configurations the payload release assembly may be configured for adjustment or repositioning along the launch cart. FIGS. 9J-L illustrate a closeup of a coupling mechanism 914 of the payload release assembly secured to a portion 916 of the HAP. As seen in FIG. 9L, the portion 916 includes a shaft member 918 and a crossbar 920 arranged perpendicular to the shaft member 918. In one scenario, the shaft member 918 is part of a down connect element between the balloon envelope and the payload of the HAP. FIG. 9M is a closeup of the shaft member 918 and crossbar 920 when not coupled to the coupling mechanism.

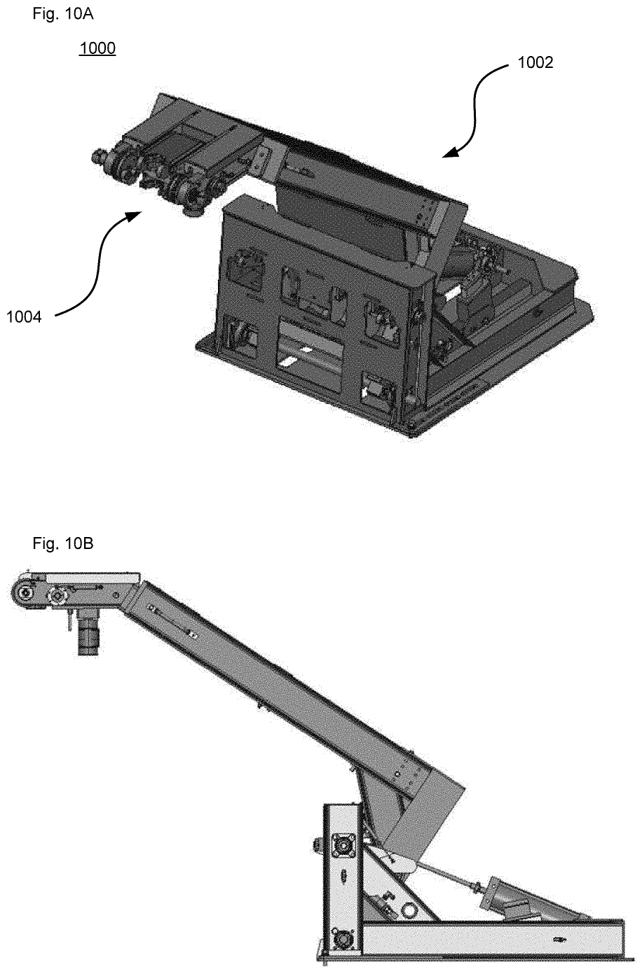

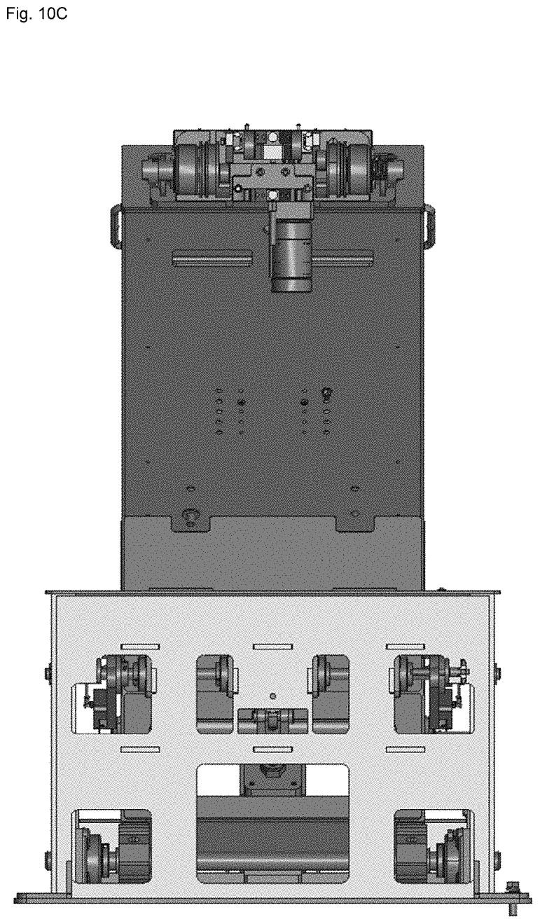

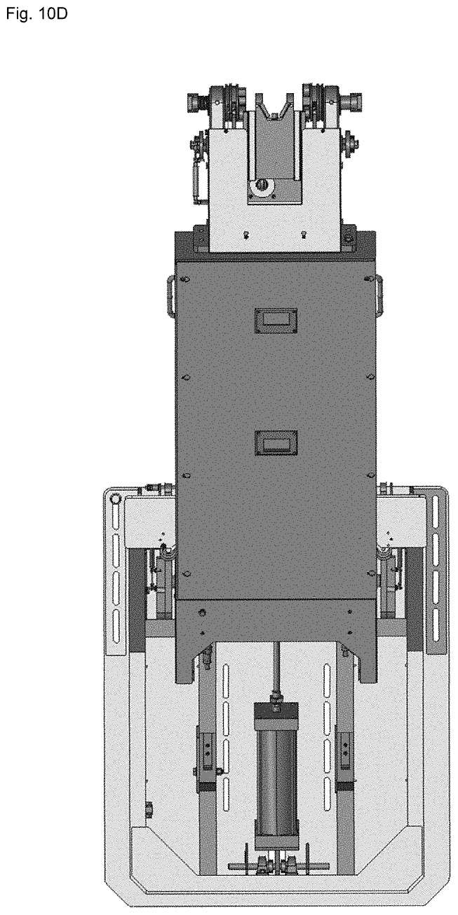

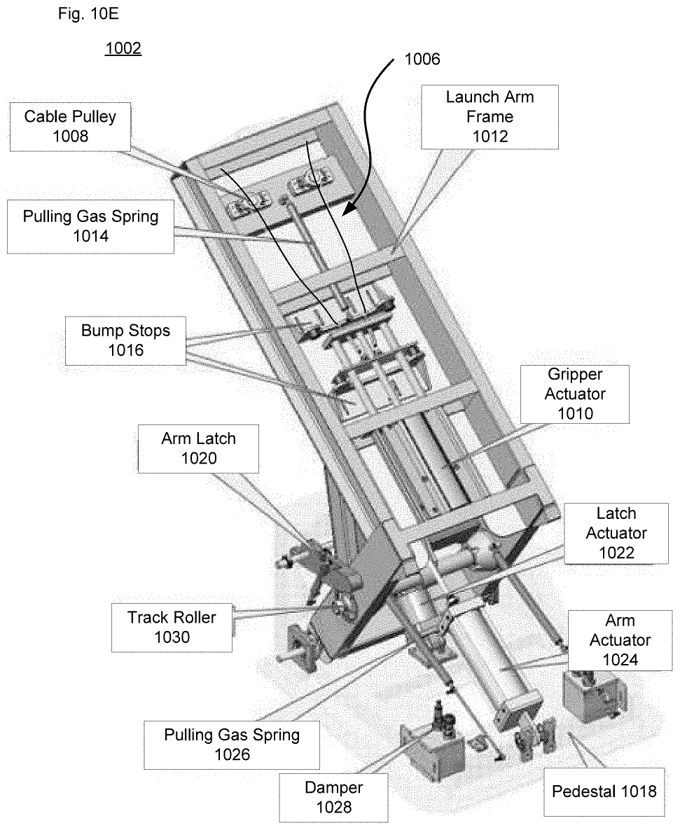

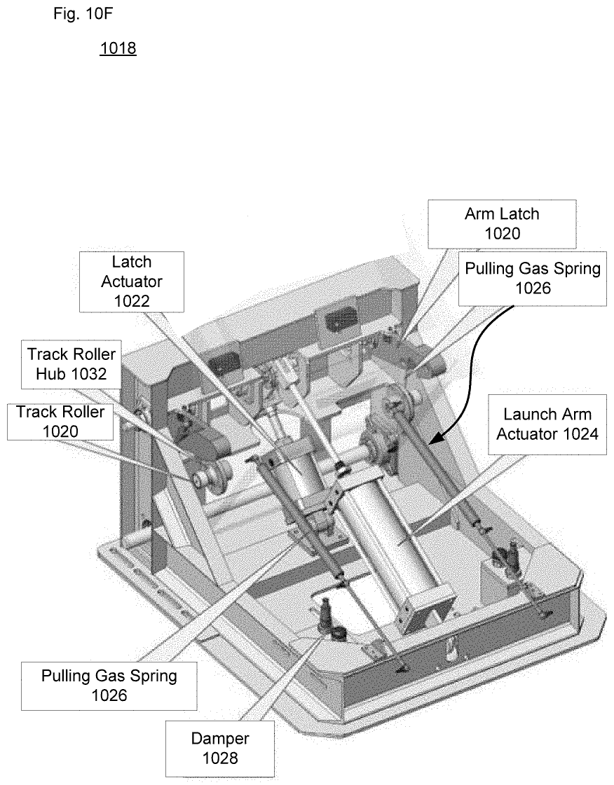

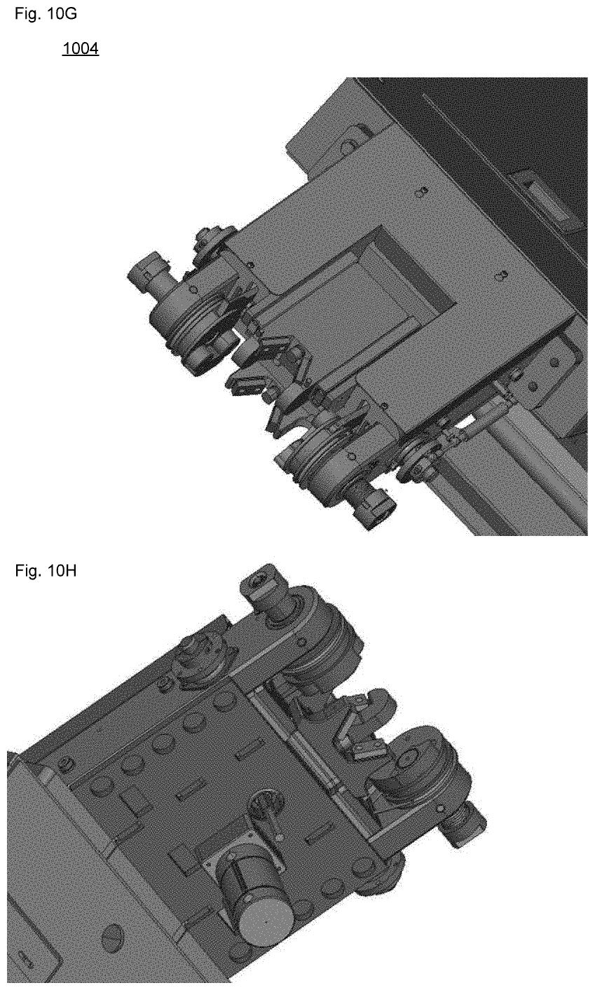

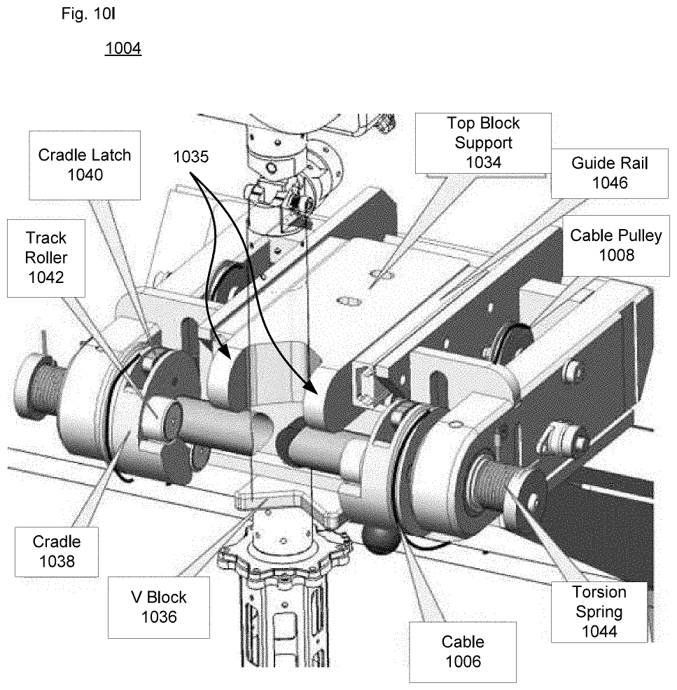

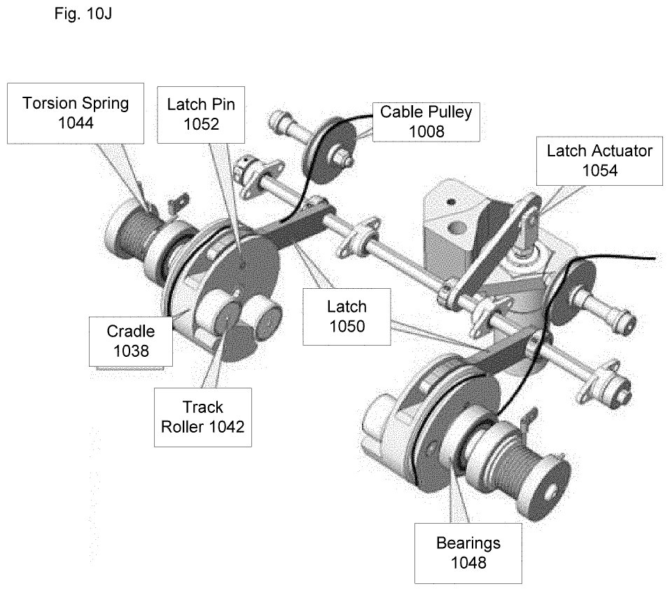

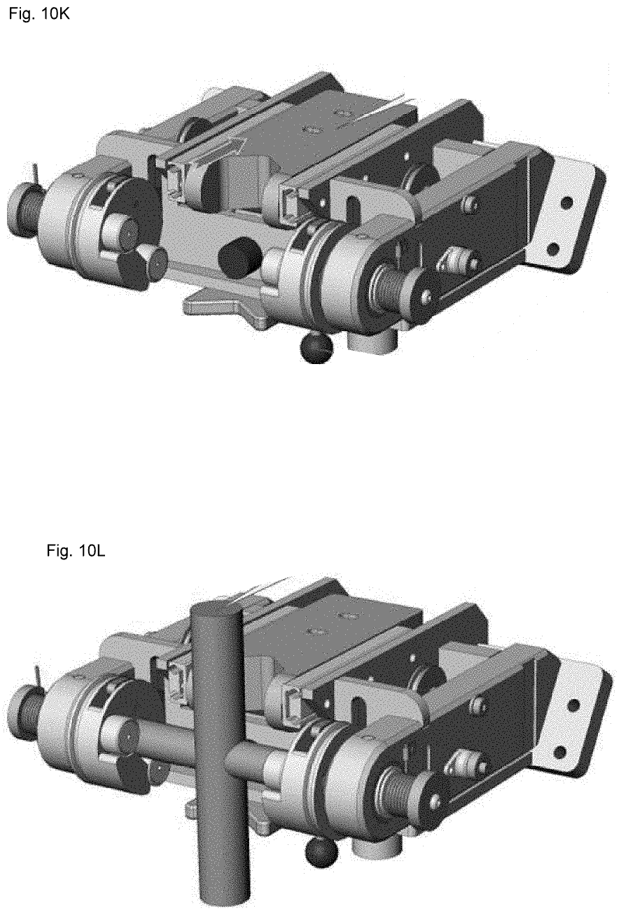

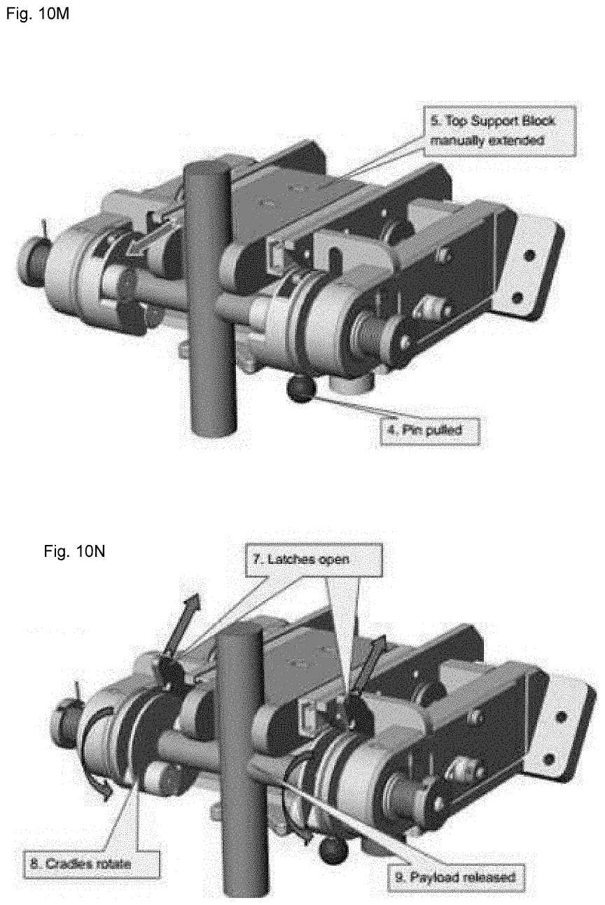

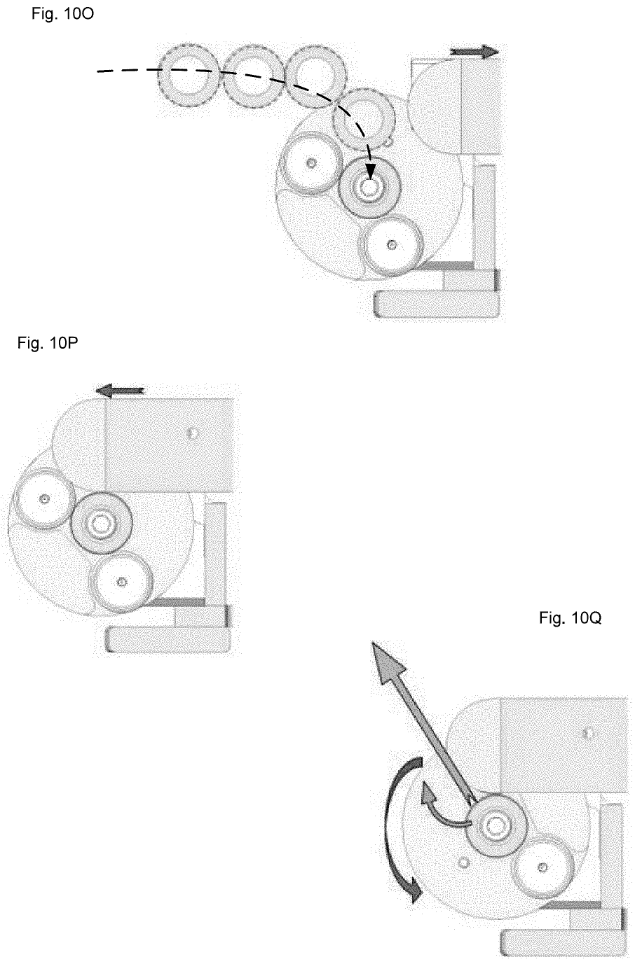

FIGS. 10A-D illustrate an example 1000 of the overall payload release assembly, which includes a launch arm assembly 1002 and a gripper assembly 1004. As seen in the partly open perspective view of FIG. 10E, the launch arm assembly 1002 includes a pair of cables 1006 coupled to corresponding cable pulleys of a pulley assembly 1008 and a gripper actuator 1010, which are received within a launch arm frame 1012. A pulling gas spring 1014 connects between the gripper actuator 1010 and the pulley assembly 1008. A pair of bump stops 1016 may be positioned to limit rotation of the cradle of the gripper assembly. As seen in FIG. 10E and the enlarged view of FIG. 10F, pedestal 1018 of the launch arm assembly may include an arm latch 1020, a latch actuator 1022, a launch arm actuator 1024, at least one pulling gas spring 1026, a damper 1028, a track roller 1030 and a track roller hub 1032.

The pulling gas spring is a normally retracted spring acting with a certain force which keeps the actuator of the gripper assembly in an extended position. The bump stops 1016 are adjustable in travel and limit the extend/retract motion of the gripper actuator. Arm latch 1020 may comprise a solid steel locking bar, which engages the track roller 1030 and prevents the rotation of the arm track roller of the gripper assembly. The track roller 1030 includes a roller bearing feature that reduces contact friction when the arm latch is disengaged from it. The pulling gas spring 1014 is a normally retracted spring configured to act with a selected amount of force that pulls on the arm and provides a force to keep it in the down position. The pedestal 1018 may be, e.g., a metal frame weldment serving as mounting base for various components. The launch arm actuator 1024 is a pneumatic actuator that operates the arm. The latch actuator 1022 is a pneumatic actuator that operates the arm latch 1020. The launch arm frame 1012 may be, e.g., a metal frame weldment serving as mounting base for the payload release mechanism and various components. The damper 1028 is used to decelerate the downward motion of the arm after HAP release.

FIGS. 10G-H illustrate top and bottom perspective views of the gripper assembly 1004, respectively, and FIG. 10I illustrates the gripper assembly 1004 with portions of the shaft member 918 of the HAP in see-through lines to illustrate certain sections of the assembly. As shown, the shaft member is received by a top block support 1034 having a pair of extended fingers (e.g., extending prongs) 1035, and a lower opposing V block 1036. The crossbar of the HAP is secured prior to launch by a pair of opposing cradles 1038. Each cradle 1038 includes cradle latch 1040 and a pair of track rollers 1042. The pull cable 1006 loops around the cradle 1038. A torsion spring 1044 is coupled to each cradle 1038. And a pair of guide rails 1046 is arranged on either side of the top block support 1034. FIG. 10J illustrates certain components of the gripper assembly, for instance with the top block support 1034, V block 1036 and guide rails 1046 omitted for clarity. Here, bearings 1048 are shown as being disposed between the cradle 1038 and torsion spring 1044. Latches 1050, connected to the cradles by latch pins 1052, is coupled to the pulling gas spring 1014 via latch actuator 1054.

The cradles 1038 comprise the primary release features for launching the payload. The cradles 1038 support and hold the crossbar 920 of the HAP and constrain the HAP in the X,Y,Z directions. The cradles 1038 are actuated (rotated) by the pull cables 1006. The cradles house the track rollers 1042, which are roller bearings that serve as cam followers and low-friction points of contact for the crossbar 920 of the HAP. The pull cables 1006 may be stainless steel cables pulled by the gripper actuator 1010, which rotate the cradles 1038. Cable pulleys 1008 serves to guide and redirect the respective pull cable 1006. Torsion springs 1044 are axially mounted with the cradles 1038, causing rotational preload on the cradles and forcing the cradles in a closed orientation prior to launch. The torsion springs 1044 also keep the cradle-end of the pull cables 1006 in tension. Bearings 1048 allow low-friction axial rotation of the cradles 1038. The V block 1036 serves as a bump stop to limit the inward travel of the shaft member 918 of the HAP. Cradle latch 1040 acts as a locking safety latch that engages on the latch pin 1052 and prevents rotation of the cradle 1038. The latch pin 1052 may be, e.g., a press-fit dowel pin that engages the cradle latch 1040 to prevent rotation of the cradle 1038. The top support block 1034 may be formed as a solid metal block that can slide in and out (towards and away from the shaft member 918), exposing a cavity into which the crossbar 920 of the HAP can be inserted. As shown in this example, the top support block 1034 contains a cutout (e.g., V-shaped or U-shaped) forming fingers 1035, which clamp down on the crossbar 920 to prevent upward motion. The guide rail 1046 may be configured as a sliding ball bearing guide rail that allows the movement of the top support block 1034 in and out. The latch actuator 1054 is, e.g., a pneumatic actuator that operates the cradle latch 1040.

Prior to securing the HAP, the to block support may be retracted and the cradles rotated into a receive position, as shown in FIG. 10K. FIG. 10L illustrates the gripper assembly once the shaft member is received. As shown in FIG. 10M, the top block support then slides to the shaft member 918 and the cradles rotate in response to movement of the cables cause by the cable pulleys so that the crossbar 920 is secured by the track rollers. Rotation of the cradles causes the torsion springs to tighten. The cradle latches are engaged by movement of the latch actuator. Once the balloon envelope is filled and the HAP is ready for launch, the latch actuator opens the cradle latches, and the cable pulleys cause the cradles to rotate so that the crossbar is no longer restrained by the track rollers, as shown in FIG. 10N. FIGS. 10O, P and Q are stylized side cutaway views illustrating the securing and release of the HAP. For instance, in FIG. 10O the shaft is shown at various steps as it enters the cradle, as indicated by the dashed arrow. Here, the short solid arrow indicates that the top block support is retracted. FIG. 10P illustrates that the top block support moves toward the shaft member. And FIG. 10Q illustrates that the rotation of the cradle moves the track rollers toward the main body of the gripper assembly so that the crossbar is disengaged and the HAP is able to float up and away from the gripper assembly.

According to one aspect of the technology, the HAP may be coupled to and released from the payload release assembly as follows. To install the HAP, the top support block 1034 is retracted in the open position, e.g., manually. This can be done by pulling a spring-actuated securing pin and pushing the top support block all the way in (away from the cradles 1038). When the top support block is pushed all the way in (see FIG. 10K), a cavity is exposed where the crossbar 920 of the HAP may be inserted. The crossbar of the HAP is inserted into this cavity and it rests on the track rollers 1042, while being pushed against the bottom V block 1036 (see FIG. 10L). The top support block 1034 may then be retracted back into the launch position by pulling the spring-actuated securing pin and pulling the top support block all the way out (towards the cradles 1038, as shown in FIG. 10M. As noted above, the V-shaped cutout on the top support block forms two extending fingers that contact the crossbar of the HAP and constrain its motion in the upward direction. By contacting the track rollers, V block, and top support block in this manner, the HAP is constrained in all directions prior to launch.

To prepare for launch, first the cradle latch 1040 and the arm latch 1020 are retracted, as they are the primary safety devices for restraining motion. The cradle latch 1040 is first disengaged to allow free rotation of the cradles 1038. To do so, the latch actuator 1022 is retracted (either manually or electrically). By retracting the latch actuator 1022, the cradle latch 1040 disengages from the latch pin 1052, allowing unrestrained rotation of the cradles 1038. Concurrently, or after a slight delay (e.g., on the order of few milliseconds) the arm latch actuator 1022 is retracted (either manually or electrically). In doing so, the arm latch 1020 moves upward, overcoming the opposing force of the pulling gas spring 1026, which serves to keep the arm latch 1020 normally closed, and disengages from the track roller 1030 mounted on the arm. This unlatching allows for unobstructed rotation of the arm.

The gripper actuator 1010 is then retracted (either manually or electrically), moving downward and overcoming the opposing force of the pulling gas spring 1026, which serves to keep the gripper actuator normally extended. This action pulls on the cables 1006, which are connected to the cradles 1038 and are guided by the cable pulleys 1008. The cables 1006 rotate the cradle 1038. The lower bump stop 1016 serves as a physical limit to the gripper actuator travel and also limits the rotation of the cradles. When the gripper actuator 1010 hits the lower bump stop 1016, the cradles 1038 are rotated to such a degree to allow for an unobstructed release of the crossbar 920 of the HAP over the fingers 1035 of the top support block 1034 due to the upward force of the HAP. Either concurrently, or after a slight delay (e.g., on the order of a few milliseconds) the arm actuator 1024 is retracted (either manually or electrically), moving downward and overcoming the opposing force of the pulling gas spring 1026, which serves to keep the arm in the down position. Towards the end of the stroke, the motion of the arm is decelerated by the damper(s) 1028, until the arm rests on the bump stops 1016. This completes the HAP release process.

An onboard control system may be employed to manage the sequence of actuations for the HAP release process. For instance, the control system may manage the sequence of operation of the cradle latches, arm latches, cradles and arm. Timing of these actuations is essential in ensuring a smooth and continuous release operation; thus a computer-implemented control system may be used. Depending on wind speeds, HAP mass, volume of gas, etc., the timing and synchronization of the aforementioned actuations may be altered and optimized to best suit the HAP release performance. Triggering the release process may be done by via remote control or can be done from a control room. One key advantage of having a control system is that all the sequencing, actuation speed, gas pressure, gas flow, etc. can be programmed and quickly executed.

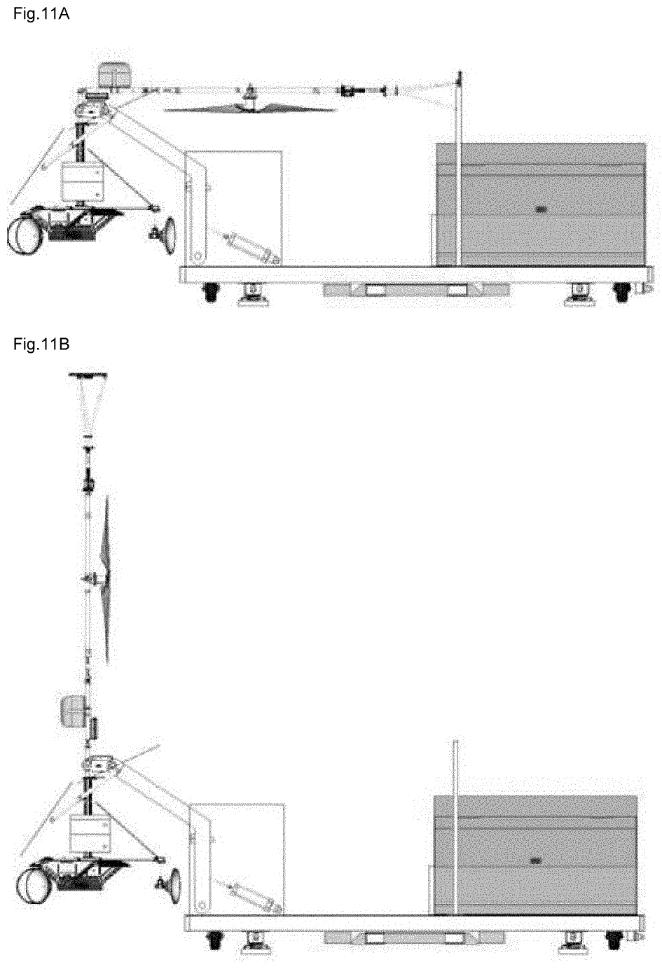

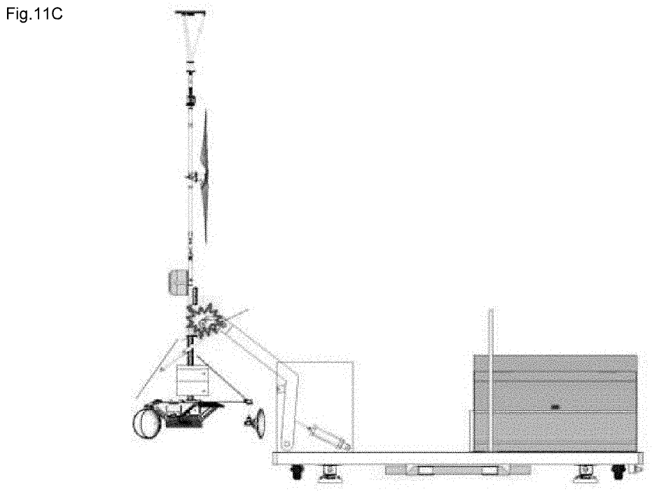

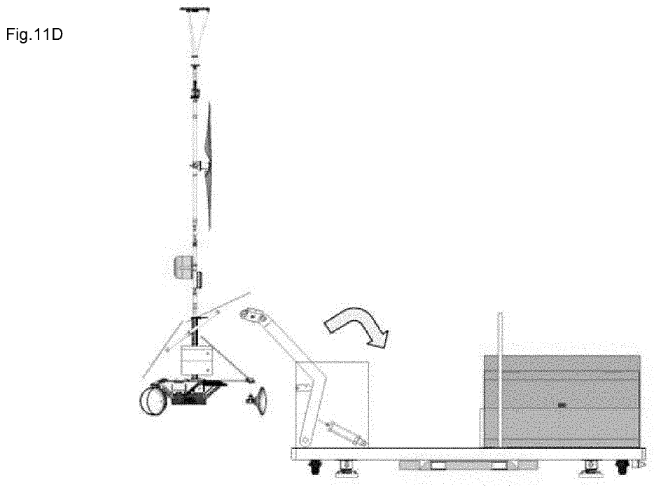

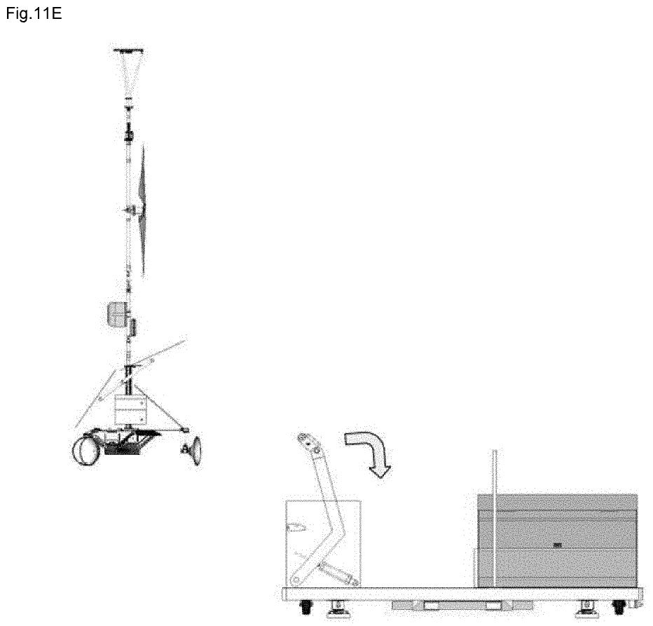

FIGS. 11A-E illustrate an overall launch process using the gripper assembly. In FIG. 11A, the HAP is disposed on the launch cart. As shown, the box or other housing with the uninflated balloon envelope is placed on the cart, while the gripper assembly secures another part of the HAP, such as a down connect member. In FIG. 11B, while the balloon is not shown, the envelope is filled with lift gas. One the envelope is filled and the HAP is ready for launch (e.g., based on wind and other environmental conditions), the gripper assembly is disengaged and the HAP is released as shown in FIG. 11C. As indicated in FIGS. 11D and 11E, as the HAP floats up from the launch cart, the payload release assembly is pulled away from the HAP, for instance by movement of the arm actuator.

Some or all of the HAP engagement and release operations may be performed manually or automatically. For instance, a control system may be located on the launch cart or the carriage. The control system may manage operation of the overall launch arm and the gripper assembly module, for example via one or more mechanical or electromagnetic (e.g., solenoid) actuators.

Using a gripper assembly and the overall payload release assembly provides significant advantages over systems that use a releasable restraint that holds down a section of the balloon envelope during fill. For instance, holding down the envelope may produce tears in the envelope material or otherwise cause strain or other damage to the envelope. This can substantially degrade the lifetime of the HAP. In addition, the gripper assembly secures the HAP along multiple degrees of freedom. For example, the shaft member of the HAP is secured in a vertical direction, and is also prevented from moving laterally or rotating due to the engagement of the crossbar by the cradles. This prevents the HAP payload from moving until the envelope is inflated. There are additional advantages to having a HAP mounted on a moving carriage that rides on the payload bridge. For instance, the launch system can achieve dynamic launches in addition to typically static balloon launches. In particular, the equipment discussed herein allows for “catapulting” the HAP with some predetermined acceleration and/or final velocity. This approach could reduce the time for launch, improve controllability, and increase longevity of the envelope by minimizing time spent on the ground.

### Example Vertical Fill Procedures

As a matter of practicality, it is necessary to maintain the balloon envelope in a desired position within the launch structure in order to fill it with lift gas safely. As the envelope is filled with lift gas, it changes shape, which can put undue stress on the envelope if the attachment points are fixed in place. Conventionally, large balloons are filled and launched from an orientation where they are partly folded and pinched in the middle with a “p-nut” style releasable restraint. However, it is desirable to fill large balloons in the vertical orientation, without folding or using a releasable restraint on the envelope for the reasons mentioned previously. As noted above, the payload release assembly can be used to constrain the HAP by securing a down connect or another part of the system rather than the envelope. In accordance with related aspects of the technology, a fill system and process are employed that modulate positioning of the envelope in the interior of the launch rig to ensure the tensioning is within predefined limits. As a result, the envelope of a high altitude platform can be filled with lift gas without placing undue stress on the inflatable housing while the payload is secured to the launch cart, so that the HAP can be launched for extended operation in the upper atmosphere.

As discussed above with regard to FIG. 11A, one end of the launch cart may include a box or other structure for holding the balloon envelope before and during inflation. In this regard, the box may be placed on the cart at one location (such as a warehouse, storage location, etc.), and the cart may be used to move the box to the support structure via the carriage and the payload bridge. Once in position on the platform within the launch facility, the envelope may be connected to the boom of the lifting assembly, for instance via the top plate along the top end of the envelope.

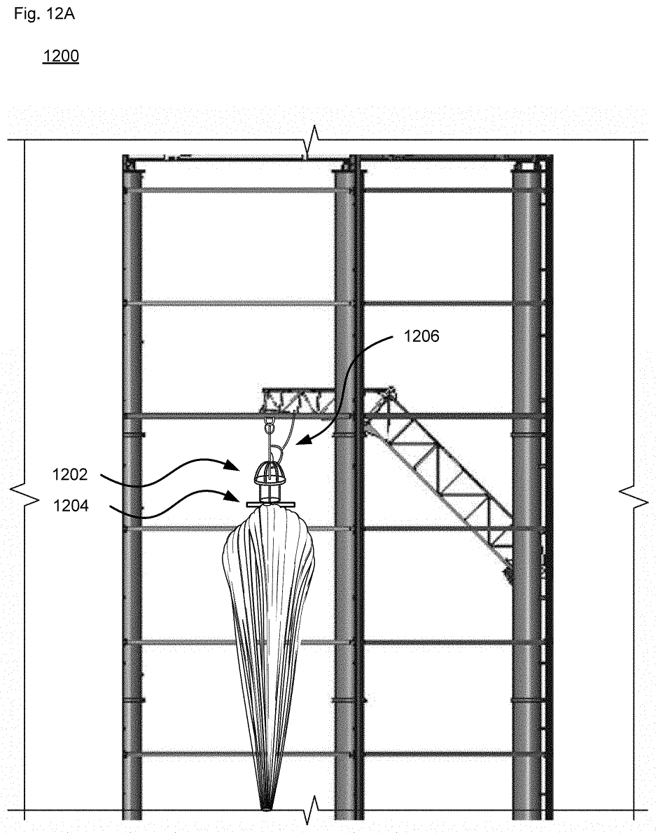

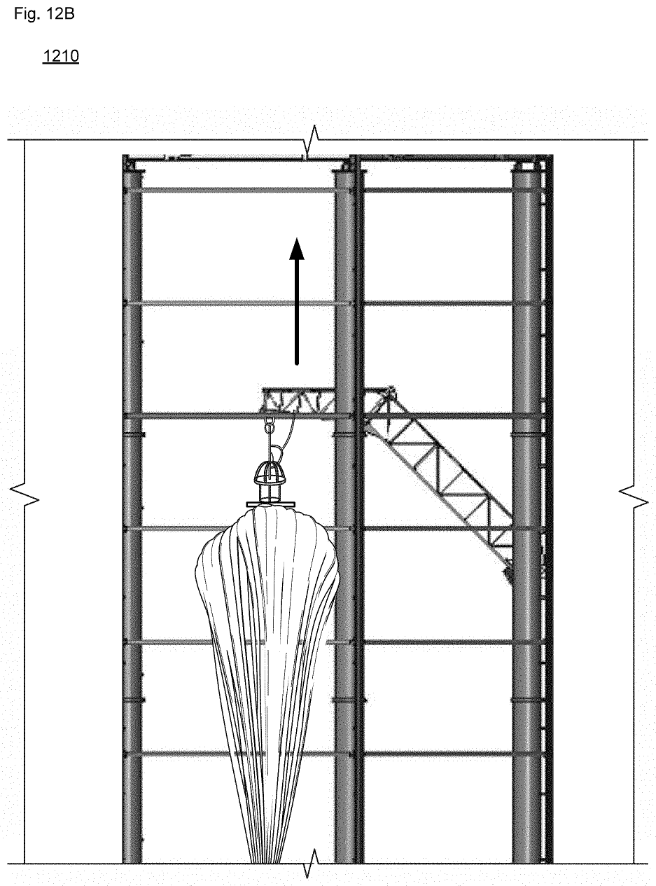

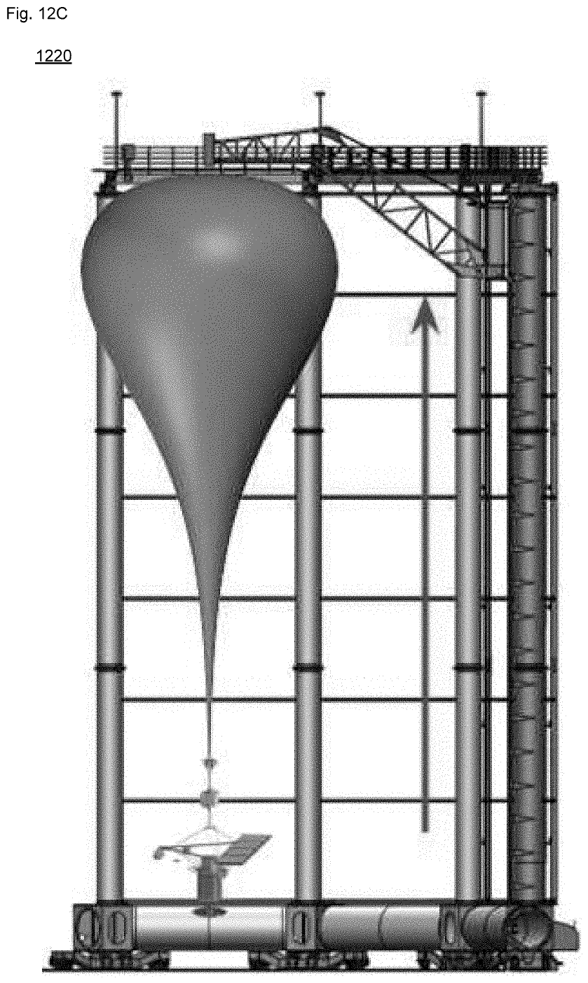

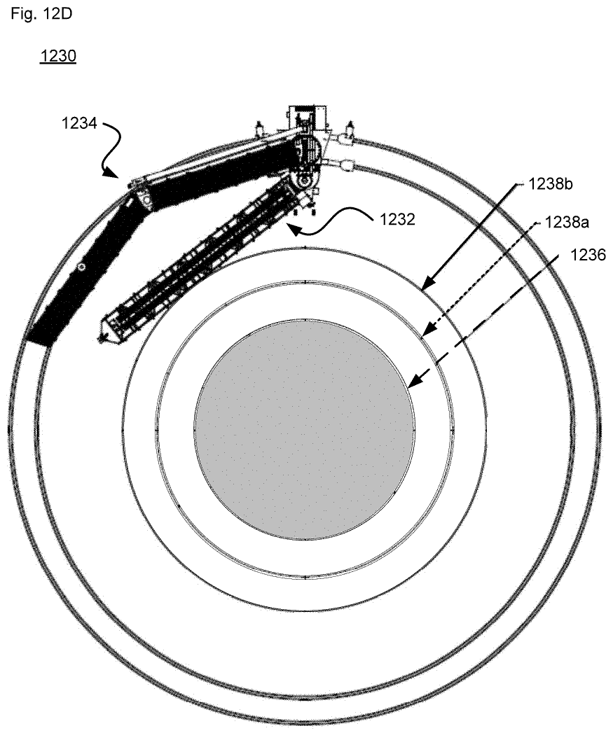

For example, in order to lift the balloon envelope out of the box, the lifting assembly may be positioned over and lowered towards the box. This may be achieved by positioning the boom and jib as needed by lowering the vertical elevator subassembly to the bottom of the support structure. FIG. 12A illustrates a view 1200 of the envelope as it is being raised out of the box, with the box and launch cart assembly omitted for clarity. As shown, an assembly 1202 for lifting and filling the balloon may be secured to the top plate 1204. The elevator subassembly can then be raised in order to raise the boom and pull the balloon envelope out of the box. Prior to or once the assembly is secured to the top plate, a lift gas supply 1206 may be connected to a fill port of the envelope along the top plate. By way of example, the lift gas supply may be coupled to a lift gas line run within or along the support structure.

As illustrated, an initial amount of gas has flowed into the balloon envelope so that it is partially filled. Here, the envelope extends a vertical distance upward from the box (omitted for clarity). In this example, as the envelope is inflated, the lifting assembly attached to the top plate may be adjusted in height (e.g., by raising the vertical elevator subassembly and/or angling the jib so as to raise the boom). Lift gas from flows into the balloon envelope via the lift gas supply until the filling is complete and the desired inflation pressure is reached within the balloon envelope.

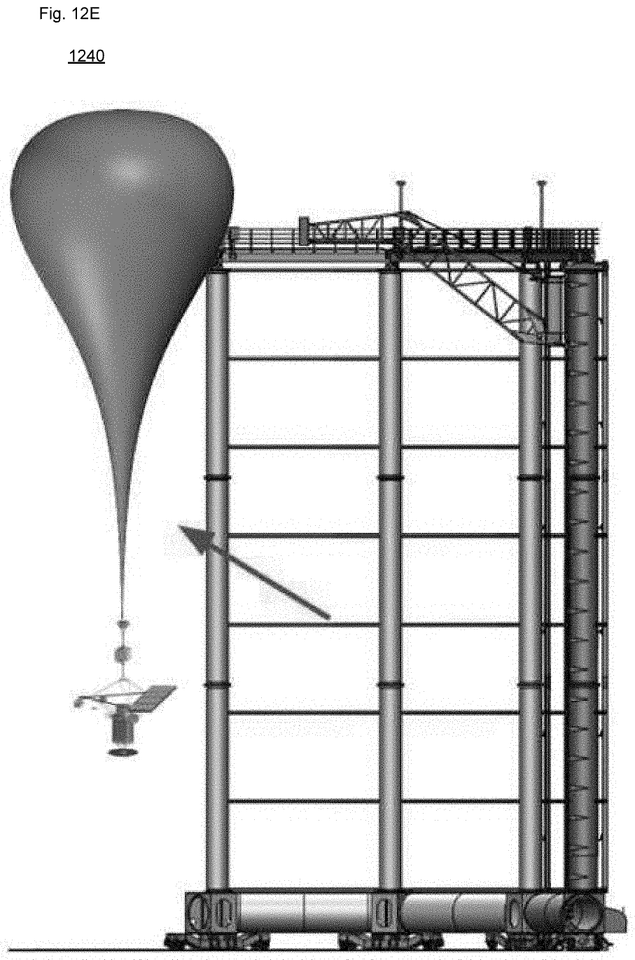

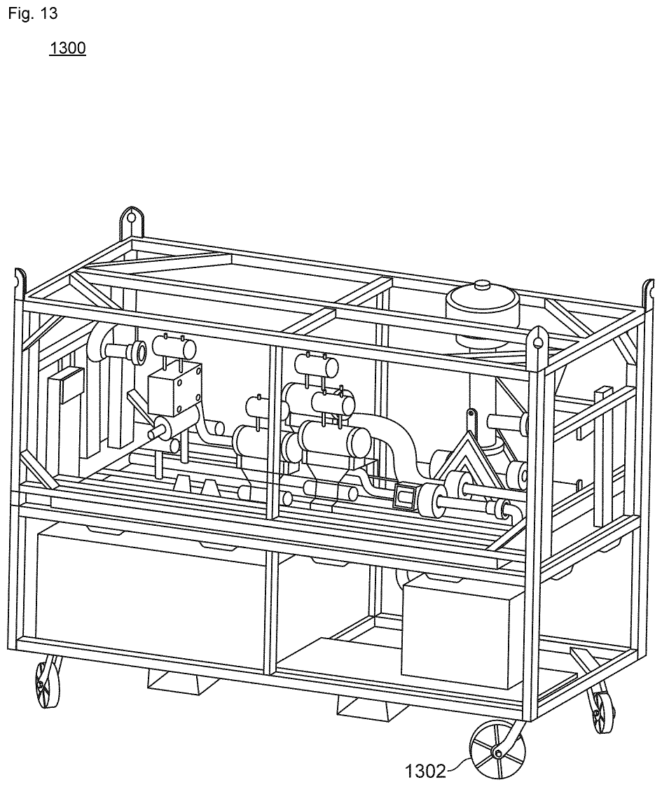

The lifting assembly used to raise the balloon envelope may be controlled in conjunction with or independently of adjustments to the support structure (e.g., rotation about the central axis and/or raising or lowering the wind blocks. In that regard, the movement of the assembly may be independent of or synchronized with the movement of the support structure. Such operations can be employed in view of data received from various sensors at the launch facility, for instance to affect balloon tilt during fill or launch. The supply lines for the lift gas may be integrated into the support structure, for instance in order to reduce the likelihood of kinking of the supply lines when the support structure is moved. Alternatively, the lift and process gasses (used for pneumatic actuation throughout the structure) may be supplied via an independent assembly, such as a pressure regulating manifold (PRM). This assembly may be located near the gas source (e.g., tube trailers, bottles or other source) to regulate high pressure gasses down to safer pressures for flowing across the launch site. This assembly can move to attach to different gas sources easily, allowing for a smooth transition between new and old gas containers. An example lift gas supply module 1300 is shown in FIG. 13.

Regardless of whether it is integrated into the support structure or is on a cart or other separate module, the lift gas supply system may include a supply of lift gases, such as hydrogen and/or helium, as well as various metering devices which provide for highly accurate metering of the amount of lift gas in the balloon envelope during inflation. The lift gas supply system also be configured to provide lift gas to the balloon envelope at very high rates of speed and a range of temperatures, such as between −20 degrees C. to 50 degrees C. In one configuration, the gases run through a section of fixed underground pipe sections to meet with a rotary union, through which they can pass into the rotating section of the launch assembly. This allows all of the lift and process gas piping fixed to the launch assembly to rotate with the structure while allowing gas flow therethrough.

There are different methods of filling a balloon vertically. These include (i) raising the top of the envelope to the ideal finished height, then filling the envelope, (ii) raising the top of the envelope to more than the ideal finished height, tensioning empty envelope, and then lowering to the ideal finished height during fill, and (ii) filling the envelope while raising it to the ideal finished height. The ideal finished height represents the position of the lifting system that would approximate the “at rest” height of a full balloon with nothing attached. The first approach (i) would start with the envelope being loose and floppy, which can place undue stress on envelope. The second approach (ii) requires some amount of envelope management, for instance by using one or more load cells to modulate the tension along the envelope during fill. The third approach (iii) is beneficial for several reasons. First, it may save a significant amount of time (e.g., on the order of 15-30 minutes) during fill. And it may improve the envelope management process and place less total stress on the envelope before and during fill.

With regard to the second approach, in one scenario a load cell is coupled between the boom and the top plate. In another scenario, a load cell may be coupled between the payload release assembly secured to the down connect or other portion of the HAP and the base load plate of the envelope. In yet another scenario, a first load cell may be disposed between the top plate and the boom, and a second load cell may be disposed between the base load plate and the payload release assembly. In still further scenarios, load cells may be positioned between any other portion of the envelope and the launch cart so that envelope tension may be measured during fill.

Regardless of the specific location of the load cell(s), the system may modulate the top and/or bottom (or other) attachment points of the envelope based on load cell readings referenced to the amount of lift gas that has been introduced into the envelope. By way of example, a typical balloon may weigh about 100 lbs at the top load cell before fill. During filling with lift gas, the weight goes down. Once the balloon has enough lift gas to support itself, the system may modulate the attachment points to maintain 20 to 40 lbs as measured by a load cell operatively coupled to the top plate. In contrast, if the load cell is operatively coupled to the base plate or another contact point below the portion of the envelope filling with gas (e.g., at the payload release assembly), the load cell readings would be the opposite. In this case, as the envelope fills with gas, there would be an upward force and the system may modulate the attachment points to maintain slightly more than 100 lbs.

The modulation process includes monitoring the load cell readings and adjusting modulation based on the calculated buoyancy of the amount of gas filled. As more lift gas is introduced, the logic executed, e.g., by a control system of the launch rig allows the lifting assembly to modulate within a range that is determined by the calculated buoyancy. When a threshold is reached that indicates the envelope has enough lift gas to support itself, then it free modulates, i.e., attempts to maintain a desired tension setpoint.

In one aspect, the tension measurement device may include an encoder, in which encoder positioning of the attachment points can also be used in the tension analysis. Here, the encoder would complement the load cell. Encoder positioning can include any system of measuring the location in space of the attachment point(s) of the envelope relative to the lifting assembly or the launch rig in general. It could be encoders disposed on a motor shaft of the boom, or encoders on the lifting assembly cables, or on a positioning sensor on a hydraulic cylinder of the lifting assembly.

With regard to the third approach, the balloon envelope needs to be lifted for clearance from the box, for instance by lifting it out some nominal amount (e.g., 0.25-1.0 meters away from the box) before starting to fill. In addition, the fill rate needs to be controlled (modulated) during different stages of the fill process. In particular, at a first stage (e.g., during the first 15-30% of fill as shown in view 1200 of FIG. 12A) the gas flow rate may start out slow at a first rate in order to not damage the envelope. This is because when the envelope is first pulled from the packaging in the box it is packed tightly and may be slightly tangled or twisted. A maximum flow rate could cause strain or undue stress at various points along the envelope due to the packaging. Additionally, before there is sufficient gas in the balloon, the envelope is located close nearby the gas inlet to the balloon, so high flow gas could make contact with the envelope and cause damage. Once the balloon has a sufficient amount of gas, the envelope expands and holds itself away from the gas inlet with buoyancy, allowing for a faster fill rate.

At a second stage (e.g., during the next 20-60% of fill, as shown in view 1210 of FIG. 12B), once the envelope is “untangled”, the fill rate can be increased to a second rate, e.g., full flow. Here, as indicated by the arrow above the boom, the speed and position of lifting assembly is modulated, for instance based on a load cell on the fill attachment point between the boom and the top plate and/or a vertical encoder position of the boom or other component of the lifting assembly. Relevant metrics for the modulation include one or more of start height, start weight, and ideal finished height. Alternately, the fill amount and calculated buoyant force can be used to cross reference with the load cell reading and/or encoder position, which is then used to control the modulation.

With regard to modulation, in particular at stage 1, a load cell will show the weight of the balloon envelope that has been lifted out of the packaging. The upward force from the lift gas will be nominal compared to the weight of the envelope. This is the stage where the fill system ramps from a first, slow fill rate to a faster flow rate (e.g., 50-75% or up to a maximum flow rate). At this stage there is minimal modulation of the lifting assembly. During stage 2, the lift gas (at the faster flow rate) will offset the increasing weight of the balloon. As more of the balloon is lifted from the packaging, the weight shown on the load cell will increase. At the same time, as fill is progressing, the upward force of the lift gas will increase and will be supporting a noticeable portion of the weight. The change in value on the load cell will slow down during this phase. In one example, the fill system may operate at full speed (maximum flow rate), and the lifting assembly can modulate as desired. This allows for the load on the balloon to stay low, close to a target zero value, preserving the life of the balloon. With larger envelopes, it is critical lift and fill with this method, as the weight of the envelope can be hundreds of pounds (meaning the load at the apex plate would also be hundreds of pounds).

During a final, third stage, where the last 20-60% the lift gas is pumped into the envelope, the gas exerts enough upwards force to support the weight of the balloon, and the lifting assembly can modulate to the finished height. At this point (e.g., as shown in view 1220 of FIG. 12C), the lift gas is exerting enough force to support the entire weight of the envelope, and the readings of the load cell will begin decreasing towards and past zero. Here, the fill system may be operating at full speed (maximum flow rate), and the lifting apparatus can modulate as desired as indicated by the arrow to the right of the envelope. During this stage, the envelope with lift gas is pushing upwards within the launch rig, and a load cell mounted between the top plate and the boom will be reading a negative value.

At this point, the lifting assembly is modulated to keep the load close to zero. For instance, once the full envelope has been pulled from the box and fill continues, the hoist continues to modulate to keep the load close to zero. As more gas is added, the envelope further expands outward, which may require the hoist to descend slightly. This action is continued until fill is complete. The final launch height is not an exact height, and may vary based on a number of factors including keeping the load close to zero, the final fill amount, etc. In one scenario, it may be desirable to minimize stage 2. This would mean leaving the lifting assembly in place at stage 1 until sufficient lift gas has been injected, and then use the upwards force from the lift gas to modulate the lifting assembly, as in stage 3, and using this to pull the remaining envelope from the packaging. This is as opposed to lifting the envelope out of the box before the lift gas can support the entire weight of the envelope.

Once the fill process has reached the point where the envelope has enough lift gas to bring the balloon and its payload to a desired altitude in the stratosphere, the filling is stopped, the lift gas line supply is disconnected from the top plate and the HAP is readied for launch. Upon fill completion, the fill tube from the lift gas supply is crimped, permanently sealing the lift gas inside the envelope. Then the top plate 1204 may be released from the lift and fill assembly 1202. At the same time or shortly thereafter, the assembly 1202 may be pulled away from the top plate 1202 (via the slew motion of the lifting assembly). This may reduce the likelihood of damage to the balloon envelope from hitting the lifting assembly during launch. As seen in top-down view 1230 of FIG. 12D, lifting assembly 1232 has rotated towards a portion of support structure 1234 via the slewing mechanism. Here, the balloon envelope 1236 is shown within region 1238, which has an inner zone 1238a and an outer zone 1238b. In this example, 1238b represents an exclusion zone that the lifting assembly should be clear of, while 1238b represents a minimum area that the lifting assembly must be away from during launch.

At launch, as noted above the gripper assembly disengages from the down connect or other connection point along the HAP. This causes the balloon envelope to begin to rise away from the launch facility as shown in view 1240 of FIG. 12E. At an appropriate time thereafter, such as when the payload has passed over (or beyond) the support structure, the lifting assembly may return to base (e.g., ground) level, and the launch cart may be removed via the payload bridge so that a next HAP may be readied for launch.

Returning to the launch process, once fill has been completed and the fill tube has been crimped or removed from the balloon envelope, the control system may evaluate the position and orientation of the envelope, wind conditions and other factors in order to decide an appropriate time to launch. This may include the control system evaluating received sensor data, for instance from cameras or lidar that observe the balloon envelope, payload and launch facility components, and/or environmental sensors (e.g., an anemometer, thermometer, barometer, rain gauge, humidity sensor, etc.) positioned around the launch area.

Prior to, during and after the inflation, the launch rig may be moved in order to obtain the best possible launch conditions within the interior space as wind conditions around the launch rig change. For example, the wind blocks may be raised to reduce the wind within the interior space of the support structure. Even in situations where the direction of the wind changes, the support structure components may be actuated to change the position of the launch rig so that the open side (e.g., by the end of the payload bridge) is downwind. This can even further reduce the amount of wind within the interior space.

In particular, as noted above, the launch rig is configured to change its position by rotation of the support structure. For instance, one or more of the bogies of the launch rig may be driven using hydraulic drivetrains to rotate the support structure clockwise or counterclockwise about the central turntable.

The various features of the launch rig may be electrically connected to a control system. For instance, user inputs such as a controller, may be included within a cab or control center of the launch rig sized to accommodate an operator. These user inputs may allow the operator to communicate with the control system in order to control the movement of the bogies, payload release assembly, lifting assembly, gas flow of the fill assembly, raising and lowering of the wind blocks, as well as other components of the launch rig.

The operator need not rely only on visible observation of the state of the launch rig and wind conditions; rather, the launch rig may include a data acquisition system. The data acquisition system may include various sensors arranged to detect the position and location of the bogies, payload release assembly, the envelope, the lifting assembly, the wind blocks, as well as environmental sensors and other equipment used to evaluate the position and orientation of the balloon envelope prior to launch.

### Controls System & Electrical System

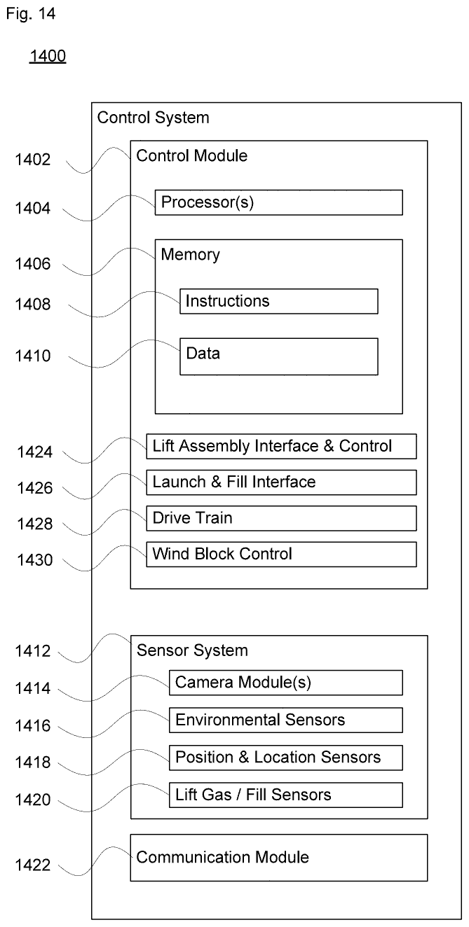

FIG. 14 illustrates an example control system 1400 configured to manage fill and launch, for instance in response to load cell measurements, wind measurements and other data obtained by the various components and sensors of the launch rig. In this regard, the control system 1400 may have a control module 1402 including one or more processors 1404, memory 1406, as well as other components typically present in general purpose computing devices. The one or more processors 1404 may be any conventional processors, such as commercially available CPUs. Alternatively, the one or more processors 1404 may be a dedicated device such as an ASIC or other hardware-based processor. The memory 1406 is configured to store information accessible by the one or more processors, including instructions 1408 and data 1410 that may be executed or otherwise used by the processor(s) 1404. The memory may be of any type capable of storing information accessible by the processor, including a non-transitory computer-readable medium or other non-transitory medium that stores data that may be read with the aid of an electronic device, such as a hard-drive, memory card, ROM, RAM, DVD or other optical disks, as well as other write-capable and read-only memories. The processor(s), control module, or memory may actually include multiple processors, control modules, or memories that may or may not be stored within the same physical housing.

The instructions 1408 may be any set of instructions to be executed directly (such as machine code) or indirectly (such as scripts) by the processor. For example, the instructions 1408 may be stored as computing device code on the computer-readable medium. The instructions 1408 may be stored in object code format for direct processing by the processor, or in any other computing device language including scripts or collections of independent source code modules that are interpreted on demand or compiled in advance. The data 1410 may be retrieved, stored or modified by processor(s) 1404 in accordance with the instructions 1408. By way of example, the instructions and data may be employed by the processor(s) for use by the control system to manage operation of different subsystems via one or more control modules as explained below.

As shown, the control system 1400 may also include sensor system 1412 that includes one or more camera modules 1414 (and/or lidar, ultrasonic or other sensors) to obtain imagery and other data about the balloon and other components within the support structure, environmental sensors 1416 to measure wind, temperature, humidity, pressure etc., position and location sensors 1418 to measure the orientation of the support structure, balloon assembly and other components, and lift gas or fill sensors 1420, for instance to measure the flow rate and volume of gas in the envelope.

In addition, the control system 1400 may include a communication module 1422 configured to send information to the ground crew and/or to a remote computer via a communication link, for instance so that an operator outside of the cab may still be able to remotely control the movement and position of the various components and subassemblies. For example, this communication link can be a wired or wireless link that uses several kinds wireless communication protocols, such as WiFi, Bluetooth or other protocols. As with control system 1400, the remote computer may include a processor and memory storing data and instructions as discussed above.

In one scenario, the control system 1400 operates autonomously. That is, rather than having an operator control the various aspects of balloon fill and/or launch, the control system may use the data from the various sensors to automatically control the movement and position of the launch rig components, as well as various other features such as gas fill, according to its instructions and in view of the position and orientation of the balloon envelope. For example, rather than having an operator adjust the position (height) of the lift assembly during fill, the control system may adjust its position automatically according to the instructions of the control system's memory. The control system may also determine when to launch the balloon based on the positioning of the envelope, wind speed and direction, etc. Of course, for safety reasons, the control system may be controlled in a manual mode by an operator either within the cab or remotely at any time. Such operation may be performed by the control module via one or more sub-modules, such as a lift assembly interface and control module 1424, a launch and fill interface module 1426, a drive train module 1428, and/or a wind block control module 1430.

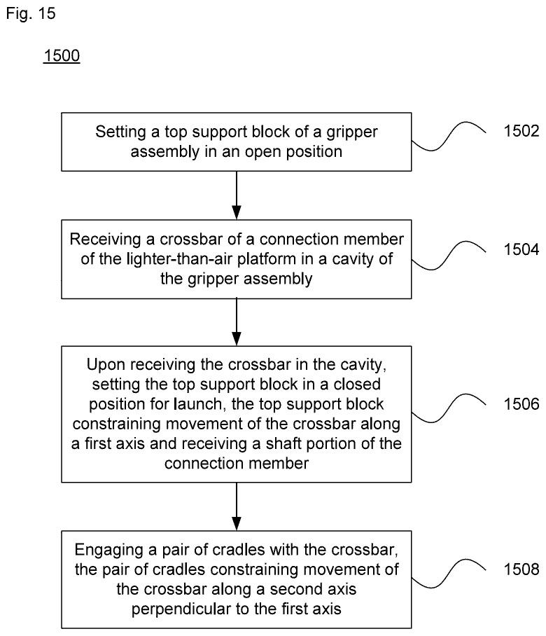

FIG. 15 is a flow diagram 1500 illustrating a method of securing a lighter-than-air platform during a launch operation. As shown in block 1502, the method includes setting a top support block of a gripper assembly in an open position. At block 1504, the method receiving a crossbar of a connection member of the lighter-than-air platform in a cavity of the gripper assembly. At block 1506, upon receiving the crossbar in the cavity, setting the top support block in a closed position for launch, the top support block constraining movement of the crossbar along a first axis and receiving a shaft portion of the connection member. And at block 1508, the method includes engaging a pair of cradles with the crossbar, the pair of cradles constraining movement of the crossbar along a second axis perpendicular to the first axis.

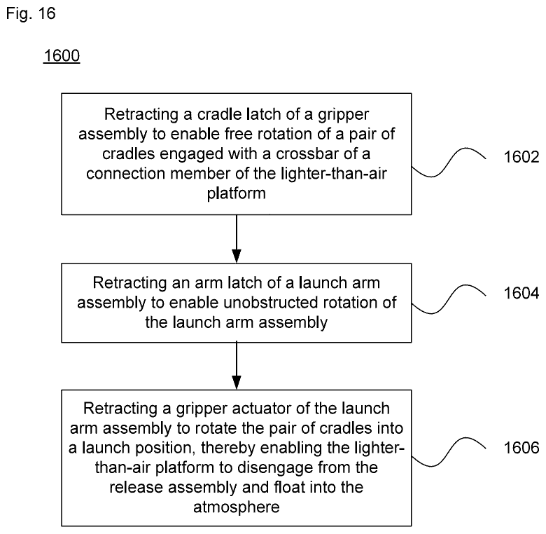

FIG. 16 is a flow diagram 1600 in accordance with other aspects described above. In particular, this flow diagram is a method of launching a lighter-than-air platform using a release assembly. The method includes at block 1602 retracting a cradle latch of a gripper assembly to enable free rotation of a pair of cradles engaged with a crossbar of a connection member of the lighter-than-air platform, at block 1604 retracting an arm latch of a launch arm assembly to enable unobstructed rotation of the launch arm assembly, and at block 1606 retracting a gripper actuator of the launch arm assembly to rotate the pair of cradles into a launch position, thereby enabling the lighter-than-air platform to disengage from the release assembly and float into the atmosphere.

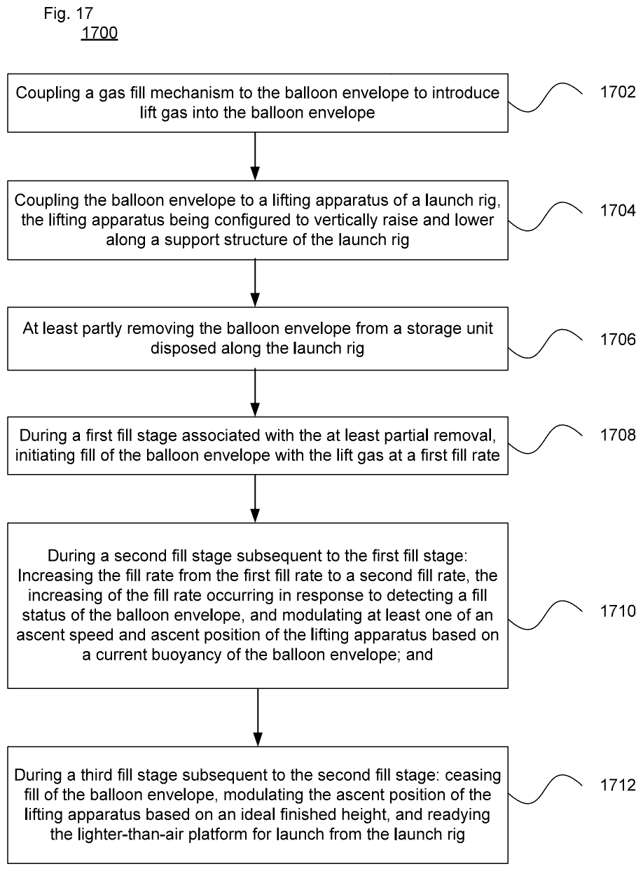

FIG. 17 is a flow diagram 1700 in accordance with additional aspects described above. In particular, this flow diagram is a method of filling a lighter-than-air platform for operation in the stratosphere, in which the lighter-than-air platform includes a balloon envelope and a payload coupled to the balloon envelope. At block 1702 the method includes coupling a gas fill mechanism to the balloon envelope to introduce lift gas into the balloon envelope, and at block 1704 coupling the balloon envelope to a lifting apparatus of a launch rig. The lifting apparatus is configured to vertically raise and lower along a support structure of the launch rig. At block 1706, the method includes at least partly removing the balloon envelope from a storage unit disposed along the launch rig. During a first fill stage associated with the at least partial removal at block 1708, the method initiates fill of the balloon envelope with the lift gas at a first fill rate. During a second fill stage subsequent to the first fill stage at block 1710, the method includes: increasing the fill rate from the first fill rate to a second fill rate, the increasing of the fill rate occurring in response to detecting a fill status of the balloon envelope, and modulating at least one of an ascent speed and ascent position of the lifting apparatus based on a current buoyancy of the balloon envelope. And at block 1712, during a third fill stage subsequent to the second fill stage, the method includes: ceasing fill of the balloon envelope, modulating the ascent position of the lifting apparatus based on an ideal finished height, and readying the lighter-than-air platform for launch from the launch rig.

Aspects, features and advantages of the disclosure will be appreciated when considered with reference to the foregoing description of embodiments and accompanying figures. The same reference numbers in different drawings may identify the same or similar elements. Furthermore, the following description is not limiting; the scope of the present technology is defined by the appended claims and equivalents. While certain processes in accordance with example embodiments are shown in the figures as occurring in a linear fashion, this is not a requirement unless expressly stated herein. Different processes may be performed in a different order or concurrently. Steps may also be added or omitted unless otherwise stated.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments.

1. A payload release assembly for securing a lighter-than-air platform during a launch operation, the lighter-than-air platform including a balloon envelope and a payload coupled to the balloon envelope, the payload release assembly comprising:
a launch arm assembly having a first end and a second end remote from the first end, the first end engageable to a launch cart that is configured to store the balloon envelope, the launch arm assembly being configured to actuate between a pre-launch position and a launch position; and
a gripper assembly operatively coupled to the second end of the launch arm, the gripper assembly being configured to secure a connection member of the lighter-than-air platform, the connection member having a shaft member and a crossbar, the gripper assembly having a first section configured to receive the shaft member and a second section configured to secure the crossbar prior to launching.

2. The payload release assembly of claim 1, wherein the first section of the gripper assembly includes a support block with a pair of fingers adapted to receive a portion of the shaft member.

3. The payload release assembly of claim 2, wherein the first section of the gripper assembly includes a pair of guide rails, and the support block slideably engages the portion of the shaft member via movement along the pair of guide rails.

4. The payload release assembly of claim 2, wherein:
the portion of the shaft member is a first portion disposed along a first side of the crossbar;
the first section of the gripper assembly further includes a receptacle block adapted to receive a second portion of the shaft member, the second portion being disposed along a second side of the crossbar opposite the first side;
wherein engagement of the first portion by the support block and engagement of the second portion by the receptable block prevent movement of the connection member along a longitudinal axis thereof.

5. The payload release assembly of claim 1, wherein the second section of the gripper assembly includes a pair of cradles configured to receive opposing ends of the crossbar.

6. The payload release assembly of claim 5, wherein each cradle includes one or more track rollers, and the cradles are rotatable to secure and release the crossbar during the launch operation.

7. The payload release assembly of claim 5, wherein the gripper assembly further includes a pair of torsion springs, a first one of the torsion springs being axially mounted to a first one of the cradles, a second one of the torsion springs being axially mounted to a second one of the cradles, wherein each of the torsion springs is configured to cause rotational preloading on the respective cradle in a closed orientation prior to launch.

8. The payload release assembly of claim 5, wherein the gripper assembly further includes a pair of cradle latches, a first one of the cradle latches being operatively engaged with a first one of the cradles, a second one of the cradle latches being operatively engaged with a second one of the cradles, wherein each cradle latch is configured to prevent rotation of the respective cradle prior to launch.

9. The payload release assembly of claim 5, further comprising one or more cables configured to actuate the pair of cradles during the launch operation.

10. The payload release assembly of claim 1, wherein the launch arm assembly includes an arm actuator configured to actuate the launch arm assembly between the pre-launch position and the launch position.

11. The payload release assembly of claim 1, wherein the launch arm assembly further includes a gripper actuator configured to cause the gripper assembly to release the connection member of the lighter-than-air platform during the launch operation.

12. The payload release assembly of claim 1, wherein the launch arm assembly further includes a damper configured to decelerate the launch arm assembly upon release of the lighter-than-air platform during the launch operation.

13. The payload release assembly of claim 1, further comprising a control system configured to manage a sequence of actuations of the launch arm assembly and the gripper assembly according to a selected timing.

14. A method of securing a lighter-than-air platform during a launch operation, the method comprising:
setting a top support block of a gripper assembly in an open position;
receiving a crossbar of a connection member of the lighter-than-air platform in a cavity of the gripper assembly;
upon receiving the crossbar in the cavity, setting the top support block in a closed position for launch, the top support block constraining movement of the crossbar along a first axis and receiving a shaft portion of the connection member; and
engaging a pair of cradles with the crossbar, the pair of cradles constraining movement of the crossbar along a second axis perpendicular to the first axis.

15. The method of claim 14, wherein:
the shaft portion is a first shaft portion; and
receiving the crossbar in the cavity further includes contacting a second shaft portion of the connection member against a receptacle block of the gripper assembly.

16. The method of claim 14, wherein setting the top support block in the open position includes retracting the top support block along a pair of guide rails.

17. The method of claim 14, wherein engaging the pair of cradles with the crossbar includes rotating the pair of cradles from a first position to a second position so that one or more track rollers on each cradle secure a section of the crossbar.

18. A method of launching a lighter-than-air platform using a release assembly, the method comprising:
retracting a cradle latch of a gripper assembly to enable free rotation of a pair of cradles engaged with a crossbar of a connection member of the lighter-than-air platform;
retracting an arm latch of a launch arm assembly to enable unobstructed rotation of the launch arm assembly; and
retracting a gripper actuator of the launch arm assembly to rotate the pair of cradles into a launch position, thereby enabling the lighter-than-air platform to disengage from the release assembly and float into the atmosphere.

19. The method of claim 18, wherein timing of retracting the cradle latch, retracting the arm latch and retracting the gripper assembly is managed by a control system based on one or more of wind speed, mass of the lighter than air platform, or volume of gas within an envelope of the lighter-than-air platform.

20. The method of claim 18, wherein retracting the gripper actuator to rotate the pair of cradles into the launch position includes pulling one or more cables to cause one or more track rollers of each cradle to rotate into a release position.
